(19) United States
(12) Patent Application Publication
(10) Pub. No.: US 2025/0168718 A1
(43) Pub. Date: May 22, 2025

(54) METHOD AND APPARATUS FOR INTERCELL CROSS-TRP SEAMLESS MOBILITY

(71) Applicant: Huawei Technologies Co., Ltd., Shenzhen (CN)

(72) Inventors: Jialin Zou, Randolph, NJ (US); Jialing Liu, Palatine, IL (US); Yunsong Yang, Hillsborough, NJ (US)

(21) Appl. No.: 19/030,554

(22) Filed: Jan. 17, 2025

Related U.S. Application Data
(63) Continuation of application No. PCT/US2023/029626, filed on Aug. 7, 2023.
(60) Provisional application No. 63/396,491, filed on Aug. 9, 2022.
(60) Provisional application No. 63/422,576, filed on Nov. 4, 2022.

(51) Int. Cl. H04W 36/00; H04B 7/06; H04W 36/32; H04W 36/36; H04W 56/00

(52) U.S. Cl. CPC H04W 36/0058; H04B 7/06952; H04W 36/00725; H04W 36/324; H04W 36/362; H04W 56/0015

(57) ABSTRACT

According to embodiments, a UE receives, from a source cell, a mobility pre-configuration radio resource control (RRC) message for random-access channel (RACH)-less access. The mobility pre-configuration RRC message indicates target timing advance (TA) assistance information. The UE receives, from the source cell, a lower layer target access command. The lower layer target access command indicates a most updated or latest network-updated time sensitive dynamic TA assistance information. The UE determines a target cell TA of a target cell based on a latest source cell TA of the source cell, a latest measured timing difference between reference signals (RSs) from the source cell and from the target cell, the most updated or latest network-updated time sensitive dynamic TA assistance information, and the target TA assistance information. The UE performs the RACH-less mobility access to the target cell based on the target cell TA.

### CROSS-REFERENCE TO RELATED APPLICATION

This patent application is a continuation of International Application No. PCT/US2023/029626 filed on Aug. 7, 2023 and entitled “Method and Apparatus for Intercell Cross-TRP Seamless Mobility,” which claims the benefit of U.S. Provisional Patent Application No. 63/396,491, filed on Aug. 9, 2022 and entitled “Method and Apparatus for Intercell Cross-TRP Seamless Mobility,” and U.S. Provisional Patent Application No. 63/422,576, filed on Nov. 4, 2022 and entitled “Method for UL RS Based TA Determination and Cell Switch Triggering,” which applications are hereby incorporated by reference herein as if reproduced in their entireties.

### TECHNICAL FIELD

The present disclosure relates generally to telecommunications, and in particular embodiments, to techniques and mechanisms for intercell mobility.

### BACKGROUND

For many wireless applications with high data rate and low latency requirements, inter-cell handover (HO) delay is still a major issue that causes service interruption and loss of throughput during mobility at the cell's-border area. Especially, in frequency range 2 (FR2) (e.g., frequencies above 24 GHz), fast moving UEs can experience significant data throughput drop and service interruption during frequent HOs.

### SUMMARY

Technical advantages are generally achieved, by embodiments of this disclosure which describe methods and apparatus for intercell cross-TRP seamless mobility.

According to embodiments, a UE receives, from a source cell, a mobility pre-configuration radio resource control (RRC) message for random-access channel (RACH)-less mobility access to a target cell. The mobility pre-configuration RRC message indicates pre-configured target timing advance (TA) assistance information. The UE receives, from the source cell, a lower layer target access command. The lower layer target access command indicates a most updated or latest network-updated time sensitive dynamic TA assistance information. The UE determines a target cell TA of a target cell based on a latest source cell TA of the source cell, a latest measured timing difference between reference signals (RSs) from the source cell and from the target cell, the most updated or latest network-updated time sensitive dynamic TA assistance information, and the pre-configured target TA assistance information. The UE performs the RACH-less mobility access to the target cell based on the target cell TA. The lower layer is a protocol layer relatively lower than layer 3 of RRC, and may be layer 1 (e.g., the physical layer) or layer 2 (e.g., the media access control (MAC) layer). Correspondingly, lower layer target access command may be a layer 1 target access command or a layer 2 target access command (e.g. a MAC control element (MAC CE)).

In some embodiments, the UE may indicate to the target cell a reference signal (RS) of a target beam selected by the UE by transmitting a corresponding sounding RS (SRS) or a RS identifier (ID) in an initial message. The association between the SRSs and the RS of candidate target beams is pre-configured.

In some embodiments, the UE may maintain pre-configured mobility parameters without performing cell switch and access to a candidate cell until the lower layer target access command is received or a cell switch triggering condition is met. The UE may perform a layer 1 (L1) measurement and tracking timing of reference signals from candidate beams to maintain synchronization with the candidate beams by periodically measuring, updating, and storing timing offsets of the candidate beams relative to a local reference time of the UE based on the pre-configured mobility parameters. The UE may update new mobility configuration parameters including the target timing TA assistance information after a mobility delta configuration message is received. The UE may apply the new mobility configuration parameters of the target cell responsive to the lower layer target access command being received or the cell switch triggering condition being met.

In some embodiments, upon the receiving the low layer target access command or a cell switch triggering condition being met at the UE, the UE may transmit, to the target cell, a RACH-less initial message and an SRS using (1) the target cell TA over a timing of an RS from a target beam of the target cell selected by the UE, (2) a pre-configured SRS uniquely corresponding to the RS from the target beam of the target cell, and (3) a pre-configured grant for the RACH-less initial message. The pre-configured grant may be pre-determined by the target cell and pre-configured to the UE at a per candidate cell basis. The RACH-less initial message may include lower layer information.

In some embodiments, the lower layer information may include a media access control (MAC) control element (CE) indicating an ID of the RS from the target beam of the target cell. The ID may be one of a synchronization signal block (SSB) ID or a channel state information (CSI) RS ID.

In some embodiments, the MAC CE may further indicate at least one of a buffer status report (BSR) or a power headroom report (PHR).

In some embodiments, the UE configured for conditional mobility may perform updates on the latest source cell TA, a source cell reference signal timing, and a target cell reference signal timing currently maintained by the UE based on the latest or most updated network-updated time sensitive TA assistance information received from the source cell. The conditional mobility may be one of conditional primary cell of secondary cell group (PSCell) addition or change (CPAC) or conditional handover (CHO). Upon a mobility condition being met, the UE configured for the conditional mobility may trigger the target cell TA derived based on the latest source cell TA, the latest measured timing difference between the RSs from the source cell and from the target cell, and the latest or most updated network-updated time sensitive TA assistance information.

In some embodiments, upon the UE configured for the CHO considering that the target cell TA determined by the UE is not valid anymore after expiry of timing alignment timer (TAT) for the most updated source cell TA, the UE may perform legacy random access to the target cell.

According to embodiments, a centralized unit (CU) determines mobility candidate cell(s) and associated transmission and reception point (TRP) (s) based on a measurement report and additional information including a predicted trajectory of a user equipment (UE). The CU sends to a candidate cell with a subset of the associated TRP(s), a mobility pre-configuration request. The CU receives, from the candidate cell, a mobility pre-configuration response indicating target cell timing advance (TA) assistance information. The CU sends, to a source cell, a second mobility pre-configuration request requesting. The CU receives, from the source cell, a second mobility pre-configuration response indicating source assistance information. The CU sends, to the source cell, a final target TA assistance information. The source cell transmits, to the UE, a mobility pre-configuration radio resource control (RRC) message for random-access channel (RACH)-less mobility access to a target cell. The mobility pre-configuration RRC message indicates the target TA assistance information.

In some embodiments, the mobility pre-configuration request may indicate a time stamp of a CU transmission timing. The target cell TA assistance information from a candidate cell may indicate a candidate cell transmission timing difference relative to the CU transmission timing and a first DL/UL asymmetry factor(s) of the candidate cell. The source cell TA assistance information from the source cell may include a source cell transmission timing difference relative to the CU transmission timing and a second DL/UL asymmetry factor(s) of the source cell.

In some embodiments, a candidate cell may determine the candidate cell transmission timing difference from the CU based on the time stamp and a first mid-haul delay between the CU and the candidate cell. The source cell may determine the source cell transmission timing difference from the CU based on the CU time stamp and a second mid-haul delay between the CU and the source cell. The CU may determine a transmission timing difference between the source cell and a target cell based on the source cell transmission timing difference and a target cell transmission timing difference from the CU. The CU may combine the source cell TA assistance information, the target cell TA assistance information, and the transmission timing difference between the source cell and the target cell to generate the final target TA assistance information.

In some embodiments, the source cell may send dynamic TA assistance information to the UE configured for conditional mobility triggered by at least one of: a source node one way delay (OWD) or a source TA change being above a threshold, and/or the change of transmission timing difference between the source cell and the target cell updated by the CU being above a timing offset threshold.

According to embodiments, a UE measures a timing offset between a UE-tracked source transmission and reception point (TRP) reference signal (RS) timing and a target TRP RS timing to obtain a latest measured timing difference between RSs from the source TRP and from a target TRP. The UE transmits, to the target TRP, an uplink signal following the UE-tracked source TRP RS timing. The UE receives a current target TA from the source TRP or the target TRP of a current serving cell. The current target TA is measured by the current serving cell of the source TRP and the target TRP on the uplink signal aligning with the UE-tracked source TRP RS timing received via the target TRP. The UE determines a target TRP TA of the target TRP based on the latest measured timing difference and the current target TA. The UE performs RACH-less mobility access to the target TRP based on the target TRP TA and a UE-tracked target TRP RS timing for the UL transmission to the target TRP.

In some embodiments, the uplink signal may be a sounding reference signal (SRS).

In some embodiments, the UE may adjust the current target TA based on the UE-tracked source TRP RS timing with the timing offset between the UE-tracked source TRP RS timing and the target TRP RS timing to obtain the target TRP TA when the UE starts to use the target TRP RS timing as a local reference to perform the UL transmission to the target TRP.

According to embodiments, a serving cell receives, via a target transmission and reception point (TRP) from a user equipment (UE), an uplink signal. The serving cell sends, via a source TRP or the target TRP to the UE, a current target TA, the current target TA measured by the serving cell on the uplink signal from the target TRP. The target TRP performs with the UE RACH-less mobility access with a target TRPTA of the target TRP based on a latest measured timing difference between RSs from the source TRP and from the target TRP, and the current target TA.

According to embodiments, a UE receives and maintains, from a serving source cell, a mobility pre-configuration message. The mobility pre-configuration message indicates L1 measurement configuration information of the serving source cell, first L1 measurement configuration information of a first candidate cell, and second L1 measurement configuration information of a second candidate cell. The second candidate cell is a subsequent cell of the first candidate cell on a predicted trajectory of the UE. The UE receives, from the serving source cell, a first lower layer target access command to switch to the first candidate cell as a target cell. The UE switches to the first candidate cell such that the first candidate cell becomes a current serving cell of the UE. The UE performs first L1 measurement based on the first L1 measurement configuration information. The UE reports, to the current serving cell, first L1 measurement results based on the first L1 measurement configuration information of the current serving cell. The UE receives, from the current serving cell, a second lower layer target access command to switch to the second candidate cell. The UE performs cell switch access to the second candidate cell as a new serving cell of the UE. The UE in the new serving cell performs second L1 measurement only based on the second L1 measurement configuration information. The UE reports, to the new serving cell, second L1 measurement results based on the second L1 measurement configuration information.

In some embodiments, the mobility pre-configuration message may be in a radio resource control (RRC) message.

In some embodiments, the L1 measurement configuration information of the serving source cell may include all L1 measurement configurations for all candidate beams of candidate cells of the serving source cell.

In some embodiments, the first L1 measurement configuration information of the first candidate cell may include all L1 measurement configurations for all candidate beams of candidate cells of the first candidate cell. The second L1 measurement configuration information of the second candidate cell may include all L1 measurement configurations for all the candidate beams of candidate cells of the second candidate cell. The first and second L1 measurement configurations described here are purely for illustration purpose without losing the generality. The number of candidate cells (and the corresponding L1 measurement configuration information) for sequential cell switch can be more (e.g., all candidate cells in the predicted trajectory of the UE).

In some embodiments, L1 measurement configuration information of the current serving cell or a candidate cell may indicate a corresponding candidate beam sweeping pattern. A candidate sweeping pattern includes a serving beam from a current or potential serving cell and the candidate beams associated with the serving beam.

In some embodiments, the UE may select a candidate beam sweeping pattern based on a current serving beam. The UE may use the current serving beam as a reference beam to perform candidate beam sweeping and candidate beam search based on the candidate beam sweeping pattern.

In some embodiments, the first L1 measurement configuration information and the second L1 measurement configuration information may be per cell based.

According to embodiments, a CU determines a sequence of mobility candidate cells based on a predicted trajectory of a user equipment (UE) and measurement reports. The CU sends, to a current serving source cell, per cell L1 measurement configurations of the current serving source cell and candidate cells. The per cell L1 measurement configurations include beam sweeping pattern(s) in a L1 measurement configuration of each cell. The current serving source cell transmits, to the UE, a mobility pre-configuration message. The mobility pre-configuration message indicates L1 measurement configuration information of the current serving source cell, first L1 measurement configuration information of a first candidate cell, and second L1 measurement configuration information of a second candidate cell. The second candidate cell is a subsequent cell of the first candidate cell on the predicted trajectory of the UE. The current serving source cell transmits, to the UE, a first lower layer target access command to switch to the first candidate cell as a target cell. After a cell switch and after the first candidate cell becomes a current serving cell of the UE, the current serving cell receives a first L1 measurement report from the UE based on configuration information of the current serving cell for first L1 measurement. The current serving cell transmits, to the UE, a second lower layer target access command for the UE to switch to the second candidate cell. After the second candidate cell becomes a new serving cell of the UE, the new serving cell receives a second L1 measurement report from the UE based on the second L1 measurement configuration information.

In some embodiments, the CU may indicate, in a mobility request in a mobility preparation phase to a candidate cell on the predicted trajectory of the UE, the current serving cell and potential serving cell(s) of the candidate cell. The candidate cell may report, to the CU, candidate beams and related L1 measurement configurations corresponding to the current serving cell and each of the potential serving cell(s).

In some embodiments, the CU may combine L1 measurement configurations of candidate beam(s) of all candidate cell(s) for the current serving cell, as L1 measurement configurations of current serving cell.

In some embodiments, the CU may combine the L1 measurement configurations of the candidate beam(s) of all the candidate cell(s) for each potential serving cell, which is currently a mobility candidate cell on the predicted trajectory of the UE, as the L1 measurement configuration of each of the candidate cell(s).

In some embodiments, the CU may determine, based on the predicted trajectory of the UE, a beam sweeping pattern of candidate beam(s) of candidate cell(s) associated with a first potential serving beam of the current serving cell or a second potential serving beam of potential serving cell(s).

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1A illustrates an example communications system, according to some embodiments;

FIG. 1B shows scenarios of an intra-cell TRP switch and an inter-cell TRP switch, according to some embodiments;

FIG. 2 shows an example of mobility pre-configuration based on UE trajectory prediction, according to some embodiments;

FIG. 3 shows example architecture and protocol of a seamless mobility scheme, according to some embodiments;

FIG. 4 shows example location-based TA estimation conducted at RAN, according to some embodiments;

FIG. 5 illustrates an example method of target TA determined at the UE, according to some embodiments;

FIG. 6 illustrates an example of the DL-based seamless mobility framework, according to some embodiments;

FIG. 7 shows an example of target TA determination with source and target DUs not time aligned, according to some embodiments;

FIG. 8 shows an example of target TA determination with DL and UL of the DUs timing asymmetry, according to some embodiments;

FIG. 9 shows an example of intra-DU/cell TRP switch, according to some embodiments;

FIG. 10 shows a flow chart of the seamless mobility function and procedure at the UE, according to some embodiments;

FIGS. 11A and 11B show a flow chart of the seamless mobility function and procedure at the network, according to some embodiments;

FIG. 12 shows a flow chart of conditional seamless mobility function and procedure at the UE, according to some embodiments;

FIGS. 13A and 13B show a flow chart of conditional seamless mobility function and procedure at the network, according to some embodiments;

FIG. 14 illustrates an example of an intra-CU inter-DU HO procedure, according to some embodiments;

FIG. 15 shows an example target access command MAC CE;

FIG. 16 shows intra-DU multiple-TRP UL measurement-based TA adjustment, according to some embodiments;

FIG. 17 shows network determined source and candidate beams for the UE at the border spots;

FIG. 18 shows an example of signaling flow chart of the UL RS based mobility framework, according to some embodiments;

FIG. 19 shows an example flow chart of UL RS based mobility function and procedure at the UE, according to some embodiments;

FIG. 20 shows an example flow chart of UL RS based mobility function and procedure at the CU, according to some embodiments;

FIG. 21 shows an example flow chart of UL RS based mobility function and procedure at a candidate DU/cell, according to some embodiments;

FIG. 22 shows an example of signaling flow chart of the UL RS based mobility framework, according to some embodiments;

FIG. 23A shows an example of candidate beam search with pre-configured beam sweeping pattern, according to some embodiments;

FIG. 23B shows an example of L1 measurement configuration and procedure flow chart for sequential mobility at the UE side, according to some embodiments;

FIG. 23C shows an example of L1 measurement configuration and procedure flow chart for sequential mobility at the network side, according to some embodiments;

FIG. 24A illustrates a flow chart of a method performed by a UE, according to some embodiments;

FIG. 24B illustrates a flow chart of a method performed by one or more network nodes, according to some embodiments;

FIG. 24C illustrates a flow chart of a method performed by a UE, according to some embodiments;

FIG. 24D illustrates a flow chart of a method performed by one or more network nodes, according to some embodiments;

FIG. 24E illustrates a flow chart of a method performed by a UE, according to some embodiments;

FIG. 24F illustrates a flow chart of a method performed by one or more network nodes, according to some embodiments;

FIG. 25 illustrates an embodiment communication system;

FIGS. 26A and 26B illustrate example devices that may implement the methods and teachings according to this disclosure; and

FIG. 27 shows a block diagram of a computing system that may be used for implementing the devices and methods disclosed herein, according to some embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF THE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

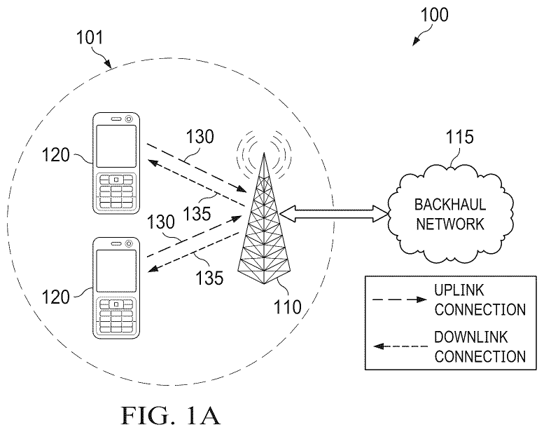

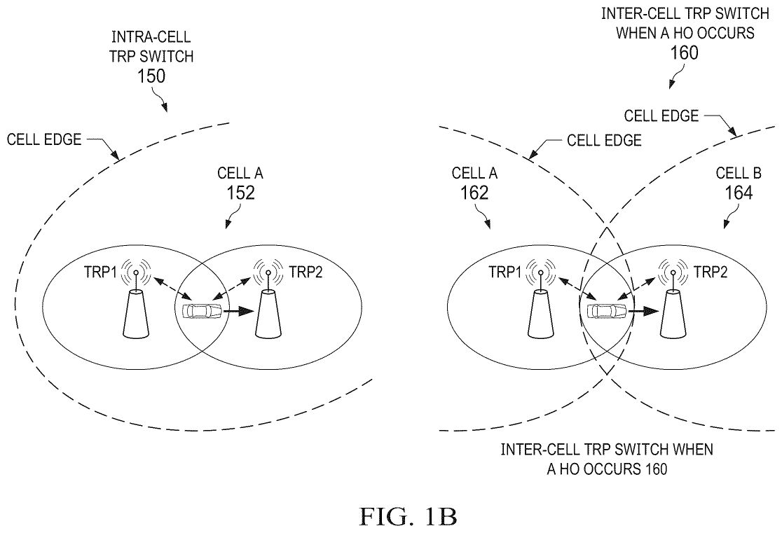

FIG. 1A illustrates an example communications system 100, according to embodiments. Communications system 100 includes an access node 110 serving user equipments (UEs) with coverage 101, such as UEs 120. In a first operating mode, communications to and from a UE passes through access node 110 with a coverage area 101. The access node 110 is connected to a backhaul network 115 for connecting to the internet, operations and management, and so forth. Communication between a UE and access node pair occur over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

In a mobility HO procedure, there are several steps on the time critical path of a HO that introduce large delays. Using the radio resource control (RRC) message as a HO command is one of them. Up to Release 17, the mobility commands including various types of HO commands and dual-connectivity (DC) primary cell of a secondary cell group (PSCell) addition or change requests are RRC reconfiguration messages.

The RRC reconfiguration messages introduce much more latency compared to layer 2 (L2) media access control (MAC) control element (CE) messages. For example, when used in PSCell addition, an RRC message takes 18˜22 ms while using MAC CE message only takes 6 ms. If layer 1 (L1) signaling (e.g. downlink control information (DCI)) is used, even less delay is expected. L1/L2 signaling has much less delay than RRC signaling. However, L1/L2 signaling message(s) cannot be large in size and can carry very limited control information.

Random access (RA) is another step on the time critical path of the mobility procedures, including the procedures of HO, DC secondary cell group (SCG) addition/activation, conditional HO (CHO), and conditional PSCell addition or change (CPAC), which contributes to the total HO delay. RAN2 delay model indicates that the delay caused by RA to the target cell is typically around 20 ms.

FIG. 1B illustrates a scenario of an intra-cell cross-transmission and reception point (TRP) switch 150 within Cell A 152 versus a scenario of an inter-cell cross-TRP switch 160 when a HO from cell A 162 to cell B 164 occurs. The intra-cell cross-TRP switch involves beam management without triggering an HO. An inter-cell TRP switch is a result of an inter-cell HO which introduces much more delay than beam management. It is desirable to minimize the HO delay such that service interruption can be minimized and the on-going data throughput during the HO can be maximized. For mobility enhancement, it is desirable to achieve UE experiences during a TRP switch of intercell HO being the same as or comparable to the intra-cell TRP switch which does not involve a HO. In principle, the resolutions to address the RRC and RA issues are:
Using RRC pre-configuration and L1/L2 signaling triggering for mobility can address the RRC delay issue.
Using RACH-less access can address the mobility delay introduced by RA.

RACH-less access is an access without performing at least some steps of RACH procedure. A RACH procedure normally includes: the UE sending a random access preamble (Message 1) to a base station or a gNB, the UE receiving a random access response (Message 2) from the base station or the gNB, UE sending a Message 3 for scheduling transmission to the base station or the gNB, and the UE receiving contention resolution (Message 4) from the base station or the gNB. This is the 4-step RACH procedure. RACH-less access can skip these 4 steps, thereby avoiding RA delay but so far it is only allowed for corner scenarios in the standards where timing advance (TA) of the target cell can be determined before HO:
In LTE, only when TA=0 (the target cell size is very small) or the TA from the source cell can be reused (e.g., source and target cells are co-located), RACH-less access is allowed.
In R17 fast SCG activation, RACH-less access to the activated PSCell is allowed only when Time Alignment Timer (TAT) is not expired and no SCG beam failure is detected

Normally, RA may be required for initial UL timing alignment and initial UL TX power. So far, the UL timing alignment and TA determination are major reasons requiring UE to perform random access to the target cell during the HO. In most mobility scenarios, RACH-less HO is not allowed due to lack of accurate and reliable target TA estimation before the HO.

In Rel-18 WID (RP-213565), “Further NR Mobility Enhancements,” one objective is L1/L2 based mobility to specify mechanism and procedures of L1/L2 based inter-cell mobility for mobility latency reduction including:
configuration and maintenance for multiple candidate cells to allow fast application of configurations for candidate,
dynamic switch mechanism among candidate serving cells (including SpCell and SCell) for the potential applicable scenarios based on L1/L2 signaling (RAN2, RAN1),
L1 enhancements, including inter-cell beam management, L1 measurement and reporting, beam indication, and for non-synchronized scenario to handle TA management (RAN1, RAN2),
Timing Advance management (RAN1, RAN2), and
centralized unit (CU)-distributed unit (DU) interface signaling to support L1/L2 mobility, if needed (RAN3).

The procedure of L1/L2 based inter-cell mobility are applicable to the following: scenarios:
Standalone, CA and new radio (NR)-DC case with serving cell change within one cell group (CG),
intra-DU case and intra-CU inter-DU case,
both intra-frequency and inter-frequency,
both frequency range 1 (FR1) and frequency range 2 (FR2), and
that source and target cells may be synchronized or non-synchronized

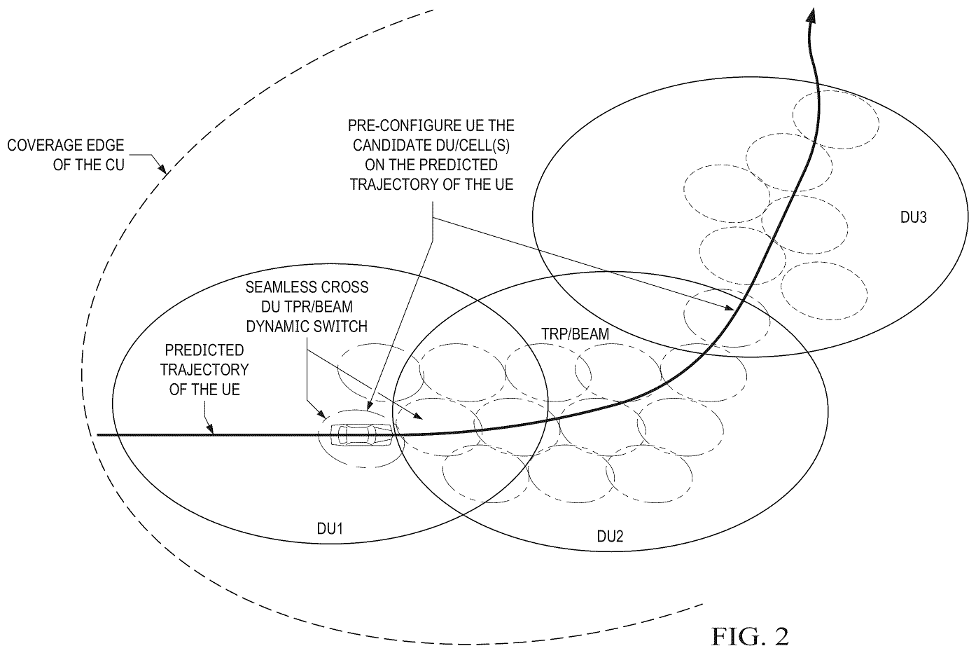

Since in Rel-18 the intra-CU inter-DU scenario requires inter-cell HO and introduces much more delay during a HO, this present disclosure focuses on the intra-CU inter-DU scenario and uses an intra-CU architecture for description. In fact, the lower layer operations disclosed in this disclosure can also be applicable to inter-CU scenarios. The strategy for achieving the Rel-18 L1/L2 based mobility for latency reduction is demonstrated in FIG. 2, and the corresponding high-level architecture and protocol are shown in FIG. 2. The lower layer is a protocol layer relatively lower than layer 3 of RRC, and may be layer 1 (e.g., a physical layer) or layer 2 (e.g., a media access control (MAC) layer).

In order to achieve the Rel-18 objective of configuration and maintenance for multiple candidate cells to allow fast application of configurations for candidate cells at the moment of cell/TRP switch, a solution may be that the network conducts a UE trajectory prediction based not only on the UE radio measurement report but also on other side-information such as UE location, speed, highway/route traffic information, trip plan information, user travel pattern/history information, etc. Then, according to the UE trajectory prediction, the network performs layer 3 (L3) pre-configuration via the RRC re-configuration message without interruption to the L1/L2 operations during the cross-cell mobility.

One possible approach is before the measurement of the candidate cell is strong enough to exceed a threshold yet, the network pre-configures candidate cells as if the network adds deactivated PSCells early, then conducts a seamless PSCell activation when it is triggered at a later time. The options include:
pre-configure and set up a split bearer with a protocol stack over the candidate cell group (similar to addition an SCG in DC if DC is supported),
pre-configure the UE early measurement/report including L1 and L3 measurements on the candidate cells/TRPs,
pre-configure the candidate target node(s) to start monitoring/detecting the UE's UL signals/initial message,
pre-reservation of the resource for access (RACH-less or RACH) to a candidate cell, and
predict the time of stay with a candidate cell/TRP and allocate related resources to the UE accordingly.

Efficient HO pre-configuration depends on that the network correctly determines the candidate DU/Cells based on the time and trajectory prediction on the UE's travelling.

After the pre-configuration, based on L1 measurement report(s) from the UE, the network sends L1/L2 signaling to the UE to activate the HO access to the target DU/TRP. The pre-configured parameters are quickly applied at the moment of activation is triggered.

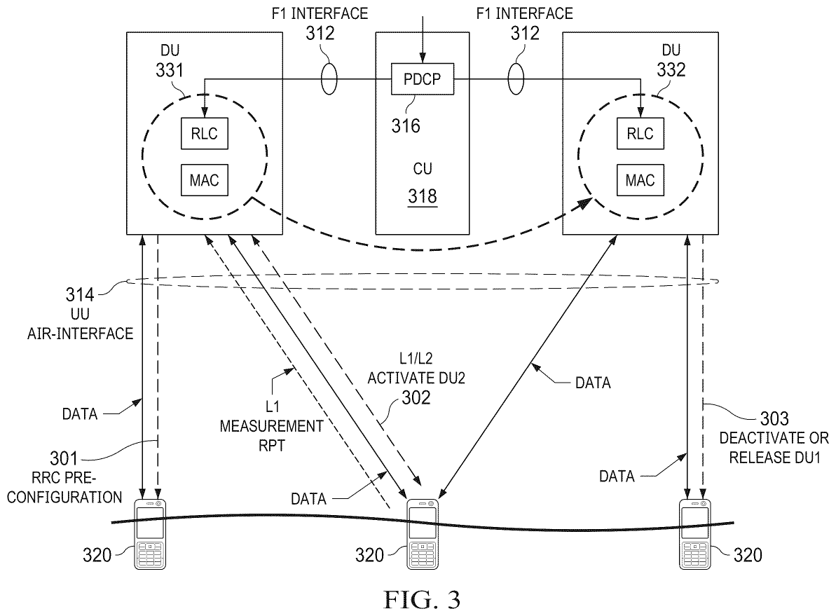

FIG. 3 shows an example of the architecture and protocol of the framework to realize the RRC pre-configuration and L1/L2 triggered mobility solution, according to some embodiments. In this example architecture of intra-CU inter-DU, the pre-configuration procedure involves signaling exchanges over the F1 interface 312 and Uu air-interface 314 as shown in FIG. 3. At the fast activation step, signaling exchanges occurs at the Uu air-interface 314. This present disclosure may have impact to both F1 and Uu interfaces, according to some embodiments.

Under the Rel-18 supported mobility scenario, intra-CU and inter-DU, DC based protocol structure may be adopted whenever possible to achieve the following:
allow DC based mobility,
achieve 0 ms interruption for both DL and UL, and
support the high throughput during the mobility.

As shown in FIG. 3, RRC pre-configuration is used by the network to conduct deactivated DU/SCG early addition and fast activation when the triggering condition is met. There are three main steps in the seamless mobility frame work.

In the first step 301, one or more than one DU/SCG can be pre-configured in deactivated state by an RRC message. With packet data convergence protocol (PDCP) 316 anchored at CU 318 unchanged, the secondary node (SN) addition and changes including master node (MN) versus SN role changes can be performed by RRC reconfiguration without resetting the radio link control (RLC) and (MAC). After the UE 320 received the RRC pre-configuration message, the UE 320 performs the L1 measurement and report for all the configured candidate cells.

In the second step 302, the network triggers inter-DU/CG fast PSCell, Scell activation based on the L1 measurement report from the UE. Upon received L1/L2 signaling for activation of the access to the target cell, the UE 320 performs RACH-less access to the target cell.

In the third step 303, CU 318 determines when a DU (e.g., DU 331 or 332) as a SN is deactivated or released. The CU notifies the involved SN and the UE. When the link with an SN (DU) cannot be maintained, the SN can be released. When the link with a SN/SCG is still good but no data need to transmits, the SN/SCG can be deactivated, the deactivated SN/SCG can be quickly reactivated again via L1/L2 signaling upon the new data arrival.

In most cases, one difficulty to bypass random access in HO is the unknown TA for uplink (UL) transmissions to the target cell. There are many efforts suggesting the network performs the target cell TA estimation before the HO is triggered. For example, location-based TA estimation or self-organizing network SON history-data-based TA estimation has a security concern when a location server is involved. The accuracy of network estimated TA can also be technically challenging.

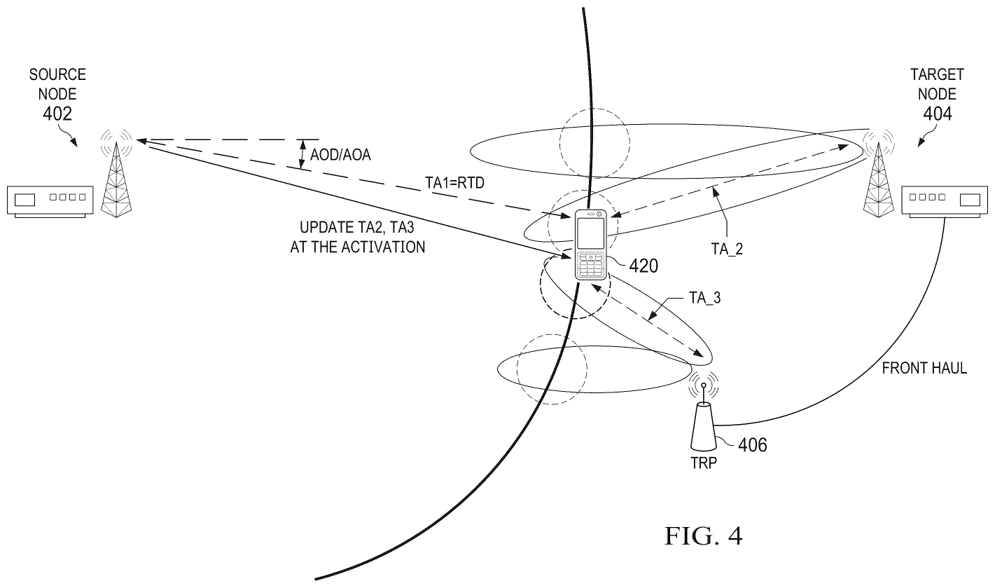

Another objective under the mobility enhancement is TA management. The TA management objective may include the initial TA determination and on-going connection TA maintenance/update. FIG. 4 shows an example of location-based TA estimation conducted at the radio access network (RAN) to avoid involving the security server.

In the scheme, the source node 402 (or the Master Node (MN) in the case of DC being enabled) estimates the target node TA (e.g. the source node 402 estimates the location of the UE 420 and based on UE location estimates the UE TA to the target SN 404/TRP 406. The source node 402 measures the angle of departure (AOD) or angle of arrival (AOA) and round-trip delay (RTD) from the UE 420 to the source node (or MN) 402. Based on the measured AOD/AOA and RTD, the source node determines the UE location. Based on the UE location and the known target node 404 (or the Secondary Node (SN) in the case of DC being enabled) location, the source node 402 determines the distance between the UE 420 and the target node 404. The source node 402 calculates the target node TA=RTD based on the UE to target node distance. In case of TRP 406, the if baseband processing is at the target node 404 (or SN), both TRP 406 location and TRP-target node (or SN) fronthaul delay may be included at the source node 402 (or MN) for target TA estimation.

At the time of mobility access activation, the source node 420 estimates the TA of the target node 404 (e.g., target TA) and sends the TA of the target node to the UE via a MAC CE. In the current standard, there is a MAC CE defined for the TA associated with the MAC entity of the current serving node, not for the target node. A new MAC CE with a new logic channel ID may be defined for current serving node (e.g. a source node 402, or a MN) to send the TA of a different node (e.g. a target node 404, or a SN) to the UE 420.

There are technical problems associated with the location-based TA estimation. To start with, UE location/distance estimation may not be very accurate based on radio measurement. In addition, multipath channels may also cause inaccuracy of TA estimation based on location/distance.

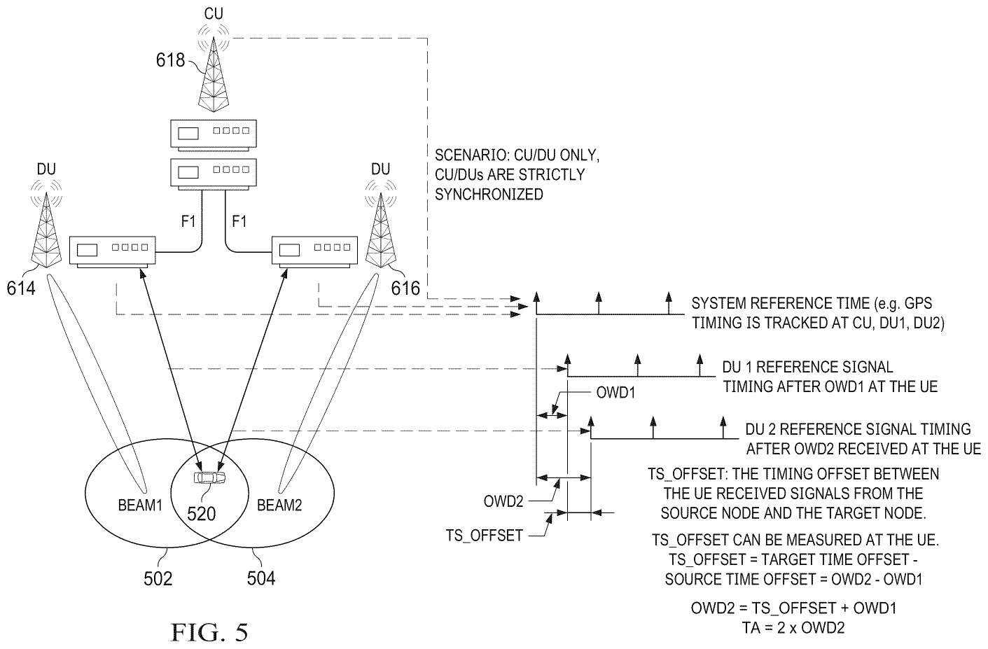

An alternative target TA estimation approach is that the UE determines the target TA based on the current source node TA and the reference signal timing offset (timing difference) between the source node and the target node which can be measured by the UE. FIG. 5 illustrates an example scenario where CU/DUs are precisely synchronized with their local reference timing precisely aligned. In this scenario, the method of the target TA determined at the UE may be possible.

In the approach shown in FIG. 5, the UE 520 may determine an uplink TA of the target cell 504 based on the modified current uplink TA of the source cell 502. The UE 520 may modify the current uplink TA of the source cell based on a difference between a measured downlink timing of the source cell 502 and a downlink timing of the target cell 504. The target TA can be presented with a general formula: Target_TA=Source_TA+2*TS_Offset.

In a 5G system, in the intercell multi-TRP environment, the situation can be much more complicated. The technical problems associated with the method shown in FIG. 5 and similar methods include:
the method does not take the source/target nodes synchronization inaccuracies into consideration;
the method does not consider any possible timing offset between the source baseband node and the target baseband node. A baseband node can be a CU or DU or even a TRP where baseband signal processing is conducted; and
The method does not consider any possible asymmetry timing offset between the UL and DL, which may be introduced by the fronthaul or configured/implemented by the operator.

Currently, the intercell mobility commands are RRC messages, and random access is performed in most intercell mobility scenarios. These commands and RA procedure cause the large delay when inter-cell TRP switch occurs, which compromises the UE experience comparing to intra-cell TRP switch.

In order to perform RACH-less HO to avoid random access delay, the target TA needs to be known by the UE before the HO; however, previous solutions for target TA estimation at the source node or UE are inaccurate, not reliable, and not applicable in most mobility scenarios under multi-cell/TRP deployment.

The current signaling and mobility procedures do not support pre-configuration/L1/L2 signaling based mobility with RACH-less target node access using UE determined target TA.

Embodiments of this disclosure minimize the delay on the time critical path of the HO procedure such that UE experiences during TRP switch of intercell HO is the same as or comparable to the intra-cell TRP switch which does not involve a HO.

According to some embodiments, in an inter-cell multi-TRP mobility environment, a method for seamless mobility based on L3 RRC pre-configuration and the L1/L2 signaling for mobility target access triggering is introduced. A RACH-less mobility access scheme for common mobility scenarios is proposed with the target cell TA (Target_TA) determined at the UE. A best beam indication mechanism is suggested to support low latency beam management.

When the UE receives the L1/L2 HO access command (e.g. a MAC CE), it determines the target_TA based on a timing offset measurement between the DL reference signals from the source node and the target node, the most updated source node TA or DL-OWD from the HO access command and the TA assistance information from the network. Then the UE, based on its determined target_TA, performs the RACH-less access to the target cell.

Handover information, including static TA assistance information, is pre-configured to the UE. Intercell HO/TRP switching is triggered by the HO access command based on L1 measurement report. Delay sensitive TA assistance information is also delivered to the UE via the HO access command.

The making and using of embodiments of this disclosure are described in detail below. It should be appreciated, however, that the present disclosure provides many applicable concepts that can be embodied in a wide variety of specific contexts. The specific embodiments discussed are illustrative of specific ways to make and use the present disclosure, and do not limit the scope of the disclosure. These and other aspects are described in greater details below. The disclosure may provide a method for applications with very high reliability, low latency and delay requirements, especially for the mobility applications in the areas of MBB and V2X. The method very reliable, accurate and efficient to minimize the delay due to mobility comparing with various existing techniques. It may be used in different systems such as NR or LTE.

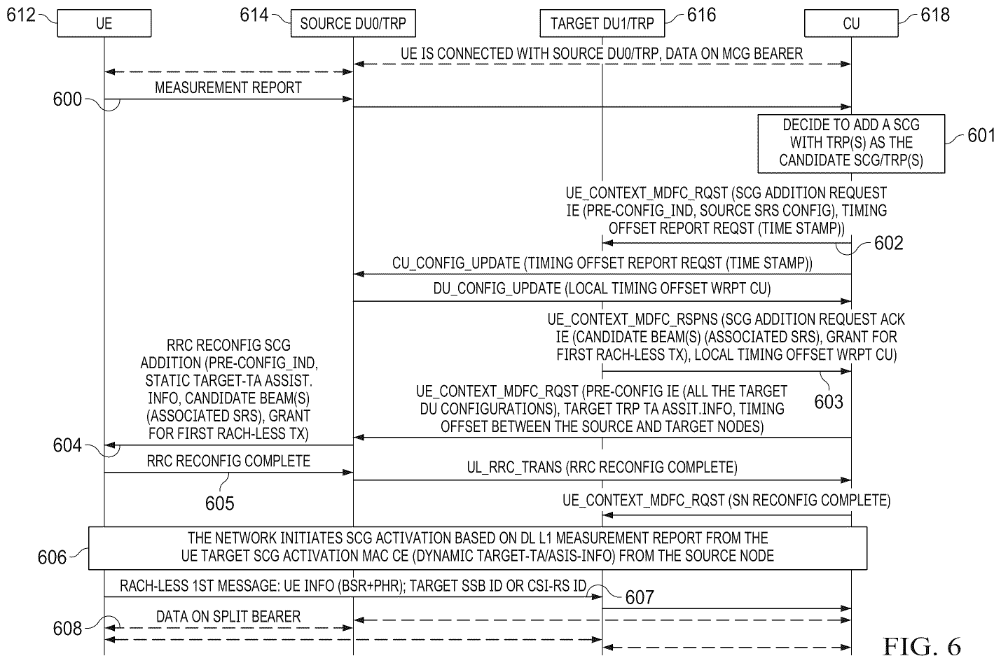

FIG. 6 illustrates an example of DL-based seamless mobility framework, according to some embodiments. At the operation 600, the UE 612 transmits to the source DU 614 a measurement report, which is forwarded to the CU 618. At the operation 601, based on measurement report and other UE traveling information, the CU 618 performs mobility prediction and decides to add a selected SN/SCG. At the operation 602, the CU 618 sends the candidate DU mobility pre-configuration (or SCG addition in a DC supported case) request information element (IE) to the target DU 616. The mobility pre-configuration IE is carried via per UE F1 message such as UE_Context_modification_request, which contains the following:
Current UE SRS configuration in-use for serving cell(s) is configured to be unique per UE in the entire CU coverage. The same SRS configuration can be used for the source DU and/or the target DU, only with different TX timings. It is optional in the pre-configuration IE in a design where no target specific SRS needs to be configured;
The Timing Offset Report Request IE with time stamp will be used in the asynchronous scenario, for example when the CU and DUs are loosely synchronized. The time stamp is sent to the candidate/target DU 616 for the CU 618 to get the timing offset between the CU and the DU (or for the MN to determine the timing offset between the MN and SN). The candidate/target DU 616 determines the transmission timing difference from the CU and reports back to the CU 618. The candidate/target DU 616 may include the DL/UL asymmetry adjustment of the fronthaul connecting the associated TRP into the candidate/target DU timing offset for reporting.

At the same time, at the operation 602.1, the CU 618 also sends a timing offset report request to the source DU 614. At the operation 602.2, upon received the timing offset report request, the source DU 614 determines the timing offset with respect to the CU reference time and reports the timing offset to the CU 618. The source DU 614 may also include the DL/UL asymmetry adjustment of the fronthaul connecting the associated TRP into the source DU timing offset.

At the operation 603, the candidate/target DU 616 sends an acknowledgement IE to the CU 618 including the L1/L2 configurations, local timing offset from CU, target C-RNTI, candidate beams, target SRS(s) corresponding to the candidate beam(s) of the candidate cell(s), and grant for first RACH-less TX. For the candidate beams, a list of the candidate SSBs and CSI-RSs of the candidate TRPs are configured to the UE 612. The UE 612 eventually selects one beam from the candidates as the target beam for the UE 612 to HO to. For the candidate beam associated SRSs, SRSs configurations correspond to each of the candidate SSBs and CSI-RSs. SRSs used here is an example. They can be any pre-defined and configured unique UL transmission waveforms one to one configured corresponding to the candidate SSBs and CSI-RSs without loss of the generality.

At the operation 603.1, after receiving all the mobility configurations from the candidate/target DU 616, the CU 618 includes all the target configuration(s) from the candidate/target DU(s) into a pre-configuration IE and forwards it to the source DU 614 via a per UE F1 message. The CU also determines the transmission timing offset between the source DU 614, and the candidate/target DU 616 based on the timing offset reports from the source and target DUs, and includes the timing offset in the F1 message to the source DU 614.

At the operation 604, upon receiving the F1 message for mobility pre-configuration from the CU, the source DU sends a pre-configuration RRC message to the UE including all the target DU configurations, static TA assistance info, and pre-configuration indication or deactivated state indication.

The static TA assistance information may include nodes_Timing_Offset. It is the timing offset between the source DU 614 and the target DU 616, which is determined by the CU 618 after issuing the pre-configuration request to the source DU 614 and candidate/target DU 616 over F1. The delta change of this offset may be updated to the UE by access activation MAC CE as part of dynamic TA assistance information.

The static TA assistance information may further include SourceTRP1_DL_Adjustment and TargetTRP2_DL_Adjustment. They are the source and target DL asymmetry adjustment factors pre-measured at the deployment of the target TRP2 with the target DU2. The asymmetry adjustment factor represents DL/UL timing offset difference due to the fiberoptics fronthaul between a TRP and its associated DU, or due to operator purposely setting. It is a per TRP factor.

A new pre-configuration message can be defined for mobility pre-configuration to differentiate from current RRC reconfiguration message and conditional reconfiguration message.

Another option is to reuse the existing RRC reconfiguration message, and define a new pre-configuration indication in the message. For mobility pre-configuration, it is set to be “true.” If DC is enabled for mobility pre-configuration, DC activation state mechanism can be reused. At the pre-configuration for a SCG addition, the activation state in the RRC reconfiguration message can be set to “deactivated.”

At the operation 605, upon receiving the pre-configuration RRC message, the UE 612 responds to the source DU 614 (source node) an RRC configuration complete message. Then, the source DU 614 forwards this info to the CU 618 and the CU 618 forwards it to the target DU 616 via F1 messages. The UE 612 performs an L1 measurement report for the pre-configured candidate cells/beams.

At the operation 606, based on the UE L1 measurement report, the network initiates the mobility access to the target cell (or SCG activation in the DC case). The source DU 614 sends a target cell access activation command (e.g. a MAC CE) to the UE 612. The new activation MAC CE includes selected best beam(s) indication, and dynamic target_TA assistance information.

At the operation 607, upon receiving the activation command (e.g. MAC CE), the UE 612 performs RACH-less access to the target node by directly transmitting the pre-granted first message to the target DU, and transmits the pre-configured SRS corresponding to the UE finally selected the target beam. The UE 612 only selects one best beam with the strongest SSB or CSI-RS as the target beam for a HO.

One alternative for UE 612 to indicate the best beam of the target cell is using the pre-granted first message to carry the ID of the reference signal (SSB_ID or CSI_ID) of the best beam. In this case, beam associated SRS is not needed. In this case, the UE could perform the early CSI report to the target node 616.

At the operation 608, the target node 616 (target DU), based on received SRS or the indication in the first message from the UE determines the DL beam selected by the UE for the following control signaling and data transmission.

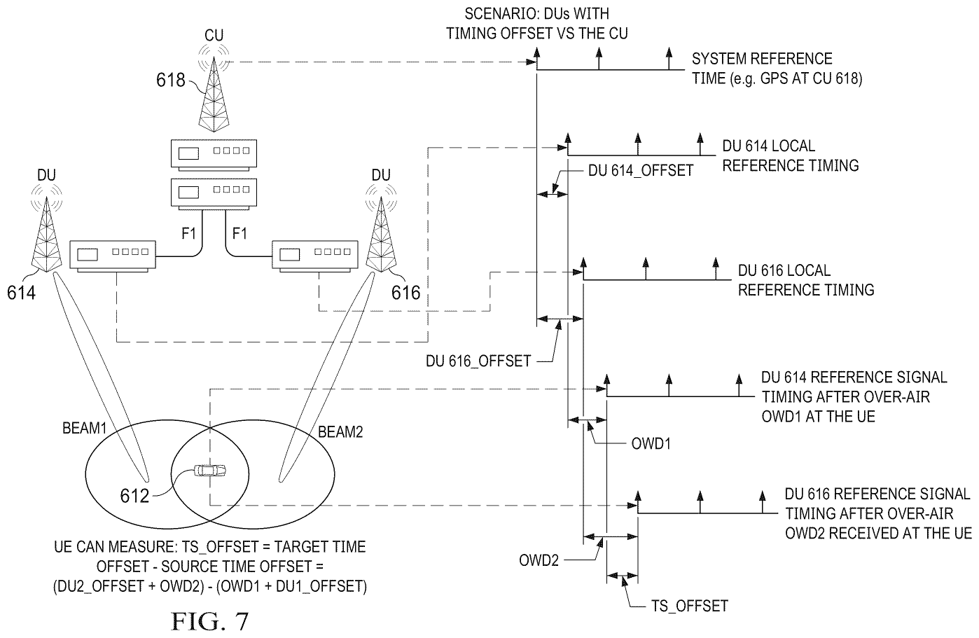

One reason that complicates TA determination at the UE based on the DL timing offset is that in many cases, the source node and the target node are not precisely synchronized (i.e., the reference base is not reliable). But, in most cases, the network can determine the timing offset between the nodes. FIG. 7 shows an example of intra-CU and inter-DU mobility where the two DUs (the source DU and the target DU) are not precisely synchronized with the CU. The CU can determine the timing offsets with the two DUs and provide the timing offset information to the UE before the handoff. Based on the assistance information from the network, the current one way delay (OWD) or TA, the UE measures the timing offset between source and target DL reference signals and determines the TA to the target cell.

The scenario in FIG. 7 demonstrates the case that the DUs have timing offset(s) from the CU reference time. As is shown in the operations 602 and 603 in FIG. 6, the CU 618 can determine the DU timing offsets before issuing the RRC HO command. The UE 612 measures the TS_offset and determines the Target_TA:

$$TS\_Offset = ( {DU}_{2} \_Offset + {OWD}_{2} ) - ( {DU}_{1} \_Offset + {OWD}_{1} ) ,$$

TS_Offset is the timing difference between the source DU 614 DL reference signal and the target DU 616 reference signal. TS_Offset has exactly the same meaning of the term Reference Signal Time Difference (RSTD) of the source node (DU 614) and the target node (DU 616). Both the terms are used in this disclosure without any difference. It can be measured by the UE 612. From this equation, the one-way radio propagation delay from the target DU 616 to the UE 612 can be calculated as:

$$\begin{matrix}{OWD}_{2} = TS\_Offset + {OWD}_{1} + {DU}_{1} \_Offset - {DU}_{2} \_Offset \\ = TS\_Offset + {OWD}_{1} + ( Source\_DU \_Offset - Target\_DU \_Offset )\end{matrix}$$

$$Target\_TA = 2 * {OWD}_{2}$$

If there is no DL/UL asymmetry, the target_TA is the RTD between the UE 612 and the target DU 616 which is twice of OWD2.

DU1_Offset and DU2_Offset are the timing offsets of DU 614 and DU 616 from the CU 618. They can be determined by the CU 618 before the HO. The value Nodes_Timing_Offset (=Source_DU_Offset-Target_DU_Offset) can be determined by the CU 618. The CU can send the Nodes_Timing_Offset to the source DU 614, and the source DU 614 sends it to the UE 612 via RRC mobility pre-configuration message.

In the case where low cost DUs are not precisely synchronized with the CU 618, whose local reference clock drifts rapidly (e.g. they can only meet the synchronization accuracy requirement for asynchronous DC), after the mobility pre-configuration is completed, the CU 618 periodically monitor the Nodes_Timing_Offset changes and update the latest offset change, Nodes_delta_offset, to the source DU 614 if the delta offset change is above a threshold.

The source DU 614 can update the Nodes_delta_offset to the UE 612 via MAC CE together with other dynamic TA assistance information.

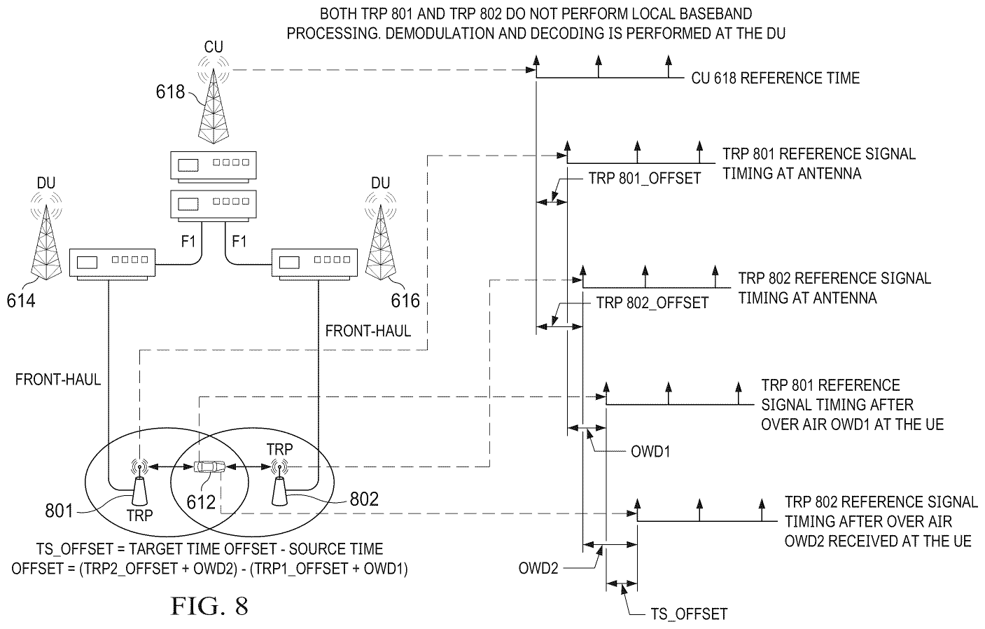

Another issue impacting the UE when determining the target_TA is the possible DL/UL timing asymmetry. This asymmetry can be introduced when the front-haul propagation delay is different for the DL versus the UL. The operator may configure/implement timing advance at the DL. But this will introduce the DL/UL timing asymmetry. In general, the DL/UL timing asymmetry offset can be pre-measured or determined at the network. FIG. 8 demonstrates a method for UE to determine the target_TA with the DL/UL timing asymmetry information provided by the network.

In this case, TRPs' DL timing offset is not the same as the UL. It may be caused by a DU advancing its TX timing such that the TRP DL transmission timing is aligned with the DL signals from the associated DU. Another cause of the UL/DL timing offset asymmetry could be the fiberoptics front-haul propagation delay difference between the DL and UL. Based on the timing offset between the source DU 614 and target DU 616 reference signals measured by the UE 612, the total DL timing offset of from the target DU2 to the UE is:

$${OWD}_{2} + {TRP}_{2} \_Offset = TS\_Offset + {OWD}_{1} + {TRP}_{1} \_Offset \qquad ( 1 )$$

OWD1 and OWD2 are the one-way delays from the UE 612 to source TRP 801 and target TRP 802 respectively. TRP1_Offset and TRP2_Offset are the DL timing offsets at the antenna of the source TRP 801 and TRP 802 relative to the source DU 614 and the target DU 616.

Consider the possible timing asymmetry with the fronthaul of DU 616/TRP 802, the TA towards the target DU 616/TRP 802 can be derived as:

$$Target\_TA = 2 * ( {OWD}_{2} + {TRP}_{2} \_Offset ) + {TRP}_{2} \_DL \_Adjustment \qquad ( 2 )$$

TRPn_DL_Adjustment is (UL timing offset-DL timing offset) associated with the fronthaul of TRPn.

The (OWD2+TRP2_Offset) in equation (2) can be substituted by equation (1), where (OWD1+TRP1_Offset) can be obtained at the DU1:
TA_DU1 measured by DU 614 is

$${TA\_DU}_{1} = 2 * {OWD}_{1} + 2 * {TRP}_{1} \_UL \_Front \_Haul \_Delay - {TRP}_{1} \_DL \_Adjustment \qquad ( 3 )$$

$${OWD}_{1} + {TRP}_{1} \_UL \_Front \_Haul \_Delay = 1 / 2 ( {TA\_DU}_{1} + {TRP}_{1} \_DL \_Adjustment )$$

$$( {OWD}_{1} + {TRP}_{1} \_Offset ) = {OWD}_{1} + {TRP}_{1} \_UL \_Front \_Haul \_Delay - {TRP}_{1} \_DL \_Adjustment = 1 / 2 ( Source\_TA {\_DU}_{1} + {TRP}_{1} \_DL \_Adjustment ) - {TRP}_{1} \_DL \_Adjustment = 1 / 2 ( Source\_TA {\_DU}_{1} - {TRP}_{1} \_DL \_Adjustment )$$

The value (OWD1+TRP1_Offset) is the DL timing offset from the DU 614 to the source TRP 801 plus the timing offset from the source TRP 801 to the UE 612. It is based on the TA measurement at the DU 614. The DU 614 sends it to the UE 612 via the activation MAC CE:

$$\begin{matrix}{OWD}_{2} + {TRP}_{2} \_Offset = TS\_Offset + {OWD}_{1} + {TRP}_{1} \_Offset \\ = TS\_Offset + 1 / 2 \\ ( Source\_TA {\_DU}_{1} - {TRP}_{1} \_DL \_Adjustment )\end{matrix}$$

Finally, the TA of the target DU 616/TRP 802 is obtained as:

$$\begin{matrix}Target\_TA = 2 * ( {OWD}_{2} + {TRP}_{2} \_Offset ) + {TRP}_{2} \_DL \_Adjustment \\ = 2 * TS\_Offset + Source\_TA {\_DU}_{1} - \\ {TRP}_{1} \_DL \_Adjustment + {TRP}_{2} \_DL \_Adjustment\end{matrix} \qquad ( 4 )$$

In summary, in equation (4), TS_Offset is measured by the UE 612 at the time of target cell access activation. Total_SourceTRP1_DLoffset is sent from the source TRP 801 to the UE 612 by the activation MAC CE. It is based on the RTD measurement at the source DU 614.

TargetTRP2_DL_Adjustment is a fixed parameter of the target TRP 802. It is sent to the UE 612 via RRC Reconfig SCG addition message. Since the TRP is transparent to the upper layers, the TargetTRP_DL_Adjustment is configured for all candidate SSB and CSI-RS(s) associated with the Target TRP 802 which may be identified by the beam set ID associated with this TRP.

An alternative can be that at the moment of target cell access activation, the source DU 614 sends the source TA_DU1 and TRP1_DL_Adjustment to the UE 612 via the activation MAC CE. Based on the information, the UE 612 can determine the Total_SourceTRP1_DLoffset and the Target_TA.

Based on the analysis above, a generic formula for determining the target TA at the UE can be developed as the following which takes synchronization inaccuracy of the baseband nodes, the timing offset between the source and the target nodes, and the front-haul DL/UL propagation timing offset asymmetry into consideration:

$$Target\_TA = 2 * TS\_Offset + Source\_TA + 2 * Nodes\_Timing \_Offset - SourceTRP\_DL \_Adjustment + TargetTRP\_DL \_Adjustment \qquad ( 5 )$$

TS_Offset is the time offset between the source reference signal and target reference signal measured by the UE.

Source_TA is the TA used by the UE for its UL transmissions to the source node/cell. It is time sensitive. At the time of target cell access activation is triggered, the most recent Source_TA is delivered to the UE via target cell access activation command (can be a MAC CE).

Nodes_Timing_Offset=Source_DU_Offset-Target_DU_Offset: including nodes timing offset configured by RRC and delta offset updated by MAC CE; it can be determined by the CU and updated to the UE.

SourceTRP_DL_Adjustment is the source DL asymmetry adjustment factor pre-measured at the deployment of the source TRP with the source DU.

TargetTRP_DL_Adjustment is the target DL asymmetry adjustment factor pre-measured at the deployment of the target TRP with the target DU.

The items in the equation (5), 2*Nodes_Timing_Offset—SourceTRP_DL_Adjustment+TargetTRP_DL_Adjustment, can be determined and combined to be one TA adjustment factor at the network. Here, this item may be named as TA_NT_Adj_Factor without loss of generality. The network includes the TA network adjustment factor in the RRC pre-configuration message and sends the message to the UE. The final target TA equation can be simplified to:

$$Target\_TA = 2 * TS\_Offset + Source\_TA + TA\_NT \_Adj \_Factor \qquad ( 5 A )$$

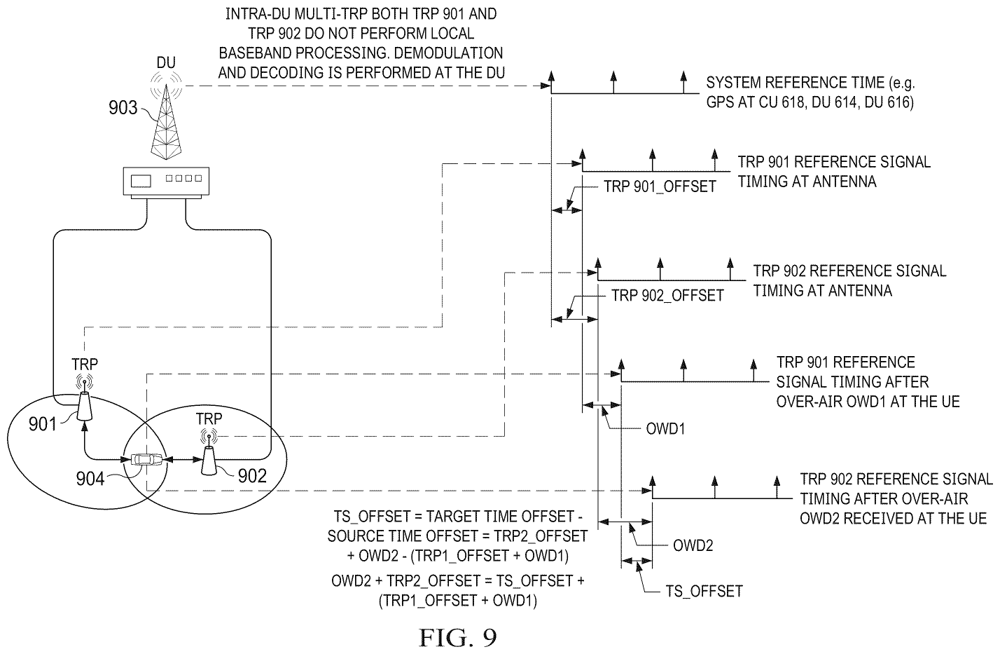

In a separate embodiment for intra-DU/cell scenario as is shown in FIG. 9, when the UE initially uses the received reference signal from TRP 901 as its local reference for transmitting its SRS and UL message, the DU 903 determined TA for TRP 901, TRP1_TA, is:

$${TRP}_{1} \_TA = 2 * ( {TRP}_{1} \_Offset + {OWD}_{1} ) \qquad ( 6 )$$

TRP1_Offset is the propagation delay of the fronthaul from the DU 903 to the TRP 901.

OWD1 is the delay over the air interface from the TRP 901 to the UE 904.

The DU 903 determined TA for TRP 902 with TRP 901 reference signal as UE local reference for TRP 902 UL transmission, TRP2_TRP1-Ref_TA, is:

$${TRP}_{2} {\_TRP}_{1} - Ref\_TA = ( {TRP}_{1} \_Offset + {OWD}_{1} ) + ( {TRP}_{2} \_Offset + {OWD}_{2} ) , \qquad ( 6 )$$

TRP2_Offset is the propagation delay of the fronthaul from the DU 903 to the TRP 902.

OWD2 is the delay over the air interface from the TRP 902 to the UE 904.

The TRP2-TRP1-Ref_TA is the TA initially the DU 903 sending to the UE 904 for the UE 904's UL transmission towards the TRP 902. However, at certain point due to mobility the UE 904 need to use the reference signal from the TRP 902 as the local reference for UL transmission to the TRP 902. When the UE 904 switches its local reference to the TRP 902 reference signal for its UL transmission to TRP 902, the new TRP2_TA should be:

$${TRP}_{2} \_TA = 2 * ( {TRP}_{2} \_Offset + {OWD}_{2} ) \qquad ( 7 )$$

With equations (6) and (7), it follows that:

$${TRP}_{2} \_TA = {TRP}_{2} {\_TRP}_{1} - Ref\_TA + ( {TRP}_{2} \_Offset + {OWD}_{2} ) - ( {TRP}_{1} \_Offset + {OWD}_{1} ) \qquad ( 8 )$$

It is already known that TS_Offset (RSTD) is:

$$TS\_Offset = ( {TRP}_{2} \_Offset + {OWD}_{2} ) - ( {TRP}_{1} \_Offset + {OWD}_{1} ) \qquad ( 9 )$$

Then, at the switch of local reference time to the timing of TRP 902 reference signal, the UE 904 could obtain its new TA to the TRP 902 without the need of waiting for the DU 903 to update the TA due to the reference switch at the UE 904. The new TRP2_TA can be obtained by adjusting the current TRP2_TRP1-Ref_TA with TS_Offset:

$${TRP}_{2} \_TA = {TRP}_{2} {\_TRP}_{1} - Ref\_TA + TS\_Offset \qquad ( 10 )$$

The UE 904 can differentiate the reference signals for TRP 901 versus TRP 902 by the reference signal set IDs associated with TRP 901 and TRP 902.

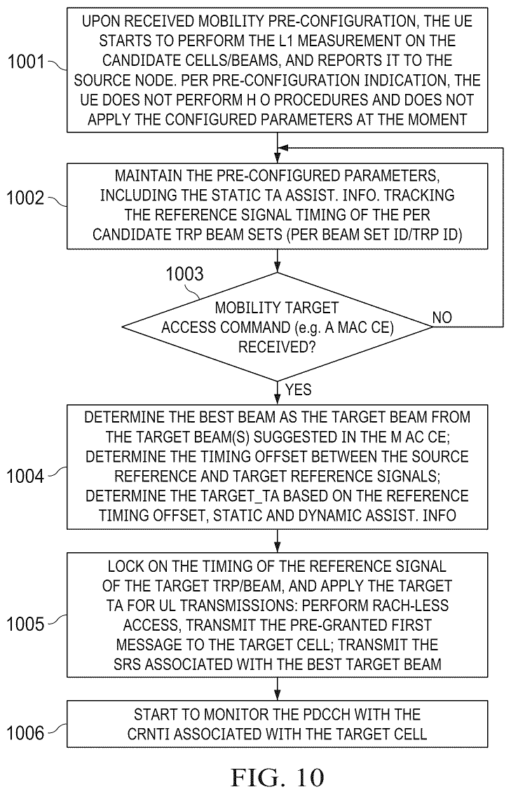

FIG. 10 shows the functions and procedure performed at the UE during the seamless inter-cell HO, according to some embodiments. At the operation 1001, based on mobility pre-configuration, the UE performs L1 measurements on the candidate cells/TRPs/beams and sends back the measurement report to the source node.

At the operation 1002, the UE tracks the reference signal timing at a per candidate TRP beam sets basis. Using the TRP_ID which is the per TRP beam-set ID as an example, the UE can track by periodically measuring, updating, and storing the timing of the strongest beam in the set. The most updated timing of the beam set of the candidate cell/TRP is used by the UE to determine the timing offset of the source and target beams at the activation of target access.

At the operation 1003, the UE determines when the mobility access command (e.g., a MAC CE) has been received.

If yes, at the operation 1004, upon receiving that L1/L2 target access command, the UE determines the best beam as the HO target beam. The UE determines the target_TA based on the measured reference signal time difference (TS_Offset/RSTD) between the source and target beams, the static and dynamic TA assistance Information.

At the operation 1005, the UE locks on the timing of the reference signal of the target beam and applies the target TA for UL transmission. The UE performs the RACH-less access to the target cell. The UE transmits the first message to the target cell with pre-granted UL resource and SRS at the timing of target_TA over the reference signal timing of the UE selected target beam of a target cell/TRP. An alternative is that no pre-granted UL resource is configured to the UE. The UE sends SRS to the target-cell/TRP at the timing of target_TA over the reference signal timing of the UE selected target beam.

At the operation 1006, the UE receives the grant from target cell PDCCH after the reception of SRS at the target cell. The UE sends out messages and/or data after connection is established with the target cell.

Another alternative without pre-granted UL resource being RRC configured to the UE is that the target PDCCH transmits the first message grant at a pre-configured timing. The UE monitors the PDCCH at the pre-configured timing after the mobility pre-configuration. The UE indicates the best target beam to the target cell in the first message or transmit pre-configured SRS associated with the selected target beam such that the target node is able to determine the best DL beam to be used for PDCCH and PDSCH transmission. The UE determine the UL receiving beam for the best reception of UL transmissions from the UE especially in FR2.

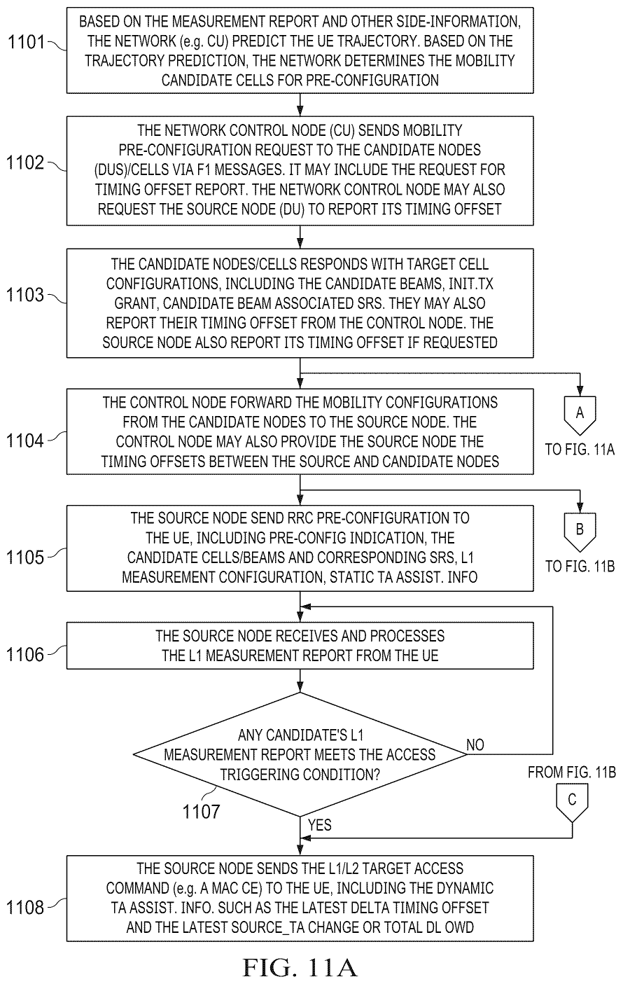

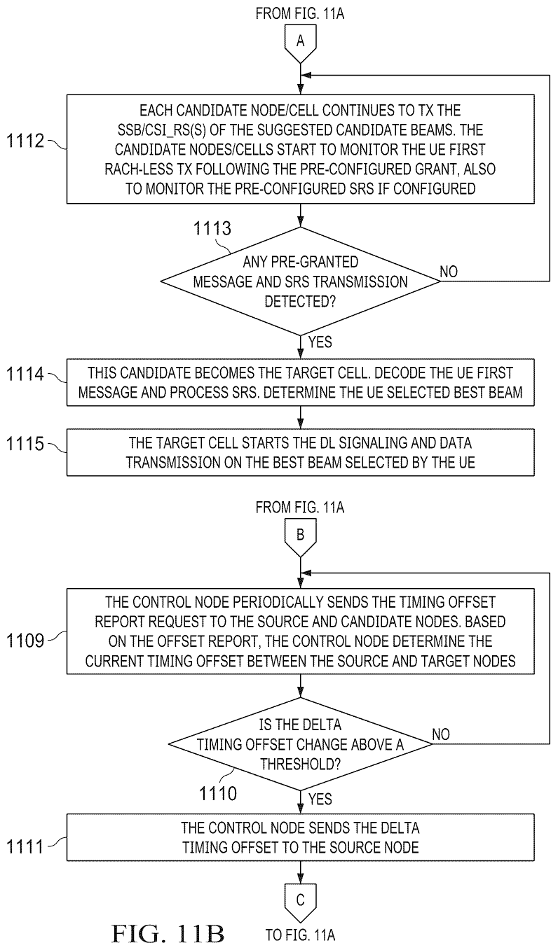

FIGS. 11A and 11B show the functions and procedure performed at the network during the seamless inter-cell HO, according to some embodiments. In the embodiments shown in FIGS. 11A and 11B, the control node (e.g., a CU, which can be the same as the mobility source node) performs UE trajectory prediction based on the measurement report and other side information. Based on the predicted UE trajectory and other information, the control node determines the HO candidate cells and performs mobility pre-configuration of the candidate cells. The pre-configuration includes those for L1 measurement, TA determination, RACH-less access, target beam selection and indication.

The control node determines the timing offset between the source node and the target node(s). The source node determines when to send the L1/L2 target access command (e.g. MAC CE) to the UE based on the UE L1 measurement report on the pre-configured candidate cells/beams. Taking MAC CE as an example, the MAC CE contains the assistance information for the UE to calculate the Target_TA including: Source_TA (most updated source TA change for UL transmission to the Source node), the candidate SSB(s) and/or CSI-RS(s), and Nodes_delta_offset.

One or more than one possible target SSB and/or CSI-RS can be indicated in the MAC CE.

The network control node sends mobility pre-configuration request to the candidate nodes (e.g., target DUs) via F1 messages. The request may include requesting for timing offset report. The network control node may also request the source node (e.g., source DU) to report its timing offset.

The target node provides the pre-configuration of the grant for the UE first RACH-less transmission to the target node. For example, the RRC configured grant can include the following.

| Pre-configured Grant Field | Number of bits |
|---|---|
| Init. Msg. PUSCH Frequency | 4 bits or any other suitable number of |
| resource allocation | bits |
| Init. Msg. PUSCH Time | 4 bits or any other suitable number of |
| resource allocation | bits |
| MCS | 5 bits or any other suitable number of |
| | bits |
| Power allocation for | 2 bits or any other suitable number of |
| Init. Msg. PUSCH | bits |

As shown in FIGS. 11A and 11B, at the operation 1101, the network control node (e.g., CU) predicts the UE trajectory based on the measurement report and other side information. The network control node determines the mobility candidate cells for configuration based on the predicted UE trajectory.

At the operation 1102, the network control node (e.g., CU) sends the mobility configuration request to the candidate nodes (e.g., DUs)/cells via F1 messages. The mobility configuration request may include the request for timing offset report. The network control node may also request the source node (e.g., source DU) to report its timing offset.

At the operation 1103, the candidate nodes/cells may respond with target cell configurations, including the candidate beams, the initial TX grant, the candidate beam associated SRS. The candidate nodes/cells may also report their timing offsets from the network control node. The source node also may report its timing offset if requested.

At the operation 1104, the network control node may forward the mobility configurations from the candidate nodes to the source node. The network control node may also provide the source node the timing offsets between the source nodes and the candidate nodes.

At the operation 1105, the source node may send the RRC pre-configuration to the UE. The RRC pre-configuration may include pre-config indication, the candidate cells/beams and the corresponding SRS, the L1 measurement configuration, and the static TA assistance information.

At the operation 1106, the source node receives and processes the L1 measurement report from the UE.

At the operation 1107, the source node determines whether any candidate's L1 measurement report meets the access triggering condition. If yes, at the operation 1108, the source node sends the L1/L2 target access command (e.g. a MAC CE) to the UE. The target access command may include the dynamic TA assistance information, such as the latest delta timing offset and the latest source TA change or total DL OWD.

At the operation 1109, the network control node periodically sends the timing offset report request to the source and candidate nodes. Based on the offset reports, the network control node determines the current timing offset between the source node and the target node.

At the operation 1110, the network control node determines whether the delta timing offset change is above a threshold. If yes, at the operation 1111, the network control node sends the delta timing offset to the source node, and the flow continues to the operation 1108 as described above.

At the operation 1112, each candidate node/cell continues to transmit the SSB/CSI_RS(s) of the suggested candidate beams. The candidate nodes/cells start to monitor the UE's first RACH-less transmission following the pre-configured grant, and to monitor the pre-configured SRS if configured.

At the operation 1113, each candidate node/cell determines whether any pre-granted message and SRS transmission is detected. If a candidate node/cell detects so, at the operation 1114, the candidate node/cell becomes the target cell, decodes the UE's first message, processes the SRS, and determines the UE selected best beam.

At the operation 1115, the target cell starts the DL signaling and data transmission on the best beam selected by the UE.

Conservative resource allocation (e.g. MCS, power) could be provided for the RACH-less initial message that the UE sends to the target node.

In LTE and R17, RACH-less access to the target is supported in certain scenarios, so far there is no concern raised on the power allocation on the initial RACH less transmission.

For the initial power allocation, a possible approach is to take a more conservative power setting similar to the power allocation for the random-access preamble following the open loop PC rule.

In a separate embodiment, if the best target beam is not indicated in the RACH-less first message, a candidate node can pre-configure SRSs associated with the candidate beams with the candidate node. After the candidate node is selected as the target node, the beam associated SRS can be used to indicate the target beam selected by the UE.

Upon received UE initial transmissions, the candidate node becomes the target node and determines the best beam selected by the UE by decoding the receive initial message or processing the received SRS. Then the target node performs the DL transmission on the best beam.

The embodiment technique reduces the delay at the time critical path of the mobility. The embodiment technique can extend the UE intracell TRP switch experience to the intercell TRP switch. It allows the seamless mobility with minimal service interruption and high data throughput during intercell mobility.

The embodiment technique provides more accurate and reliable fast TA determination method at the UE. It allows the RACH-less access in most common mobility scenarios.

In a separate embodiment, seamless mobility can also be extended to conditional HO (CHO) and conditional PSCell addition or change (CPAC). In this embodiment, similar to pre-configuration RRC message, conditional RRC message (CHO command or CPAC request) also includes the candidate SSBs and CSI-RSs with associated TargetTRP_DL_Adjustment, Nodes_timing_offset, pre-allocated grant for RACH-less access to the target cell, and SRS.

One difference between conditional seamless mobility and preconfigured seamless mobility is on the target access triggering. The former is triggered by the UE, and the latter is triggered by the network. It leads to a difference on the update of dynamic TA assistance information. In the network triggered case, the information can be updated at the target access activation. But in the conditional UE triggering case, the update has to be on-going before the conditional triggering occurs. After CHO/CPAC is started by RRC reconfiguration message, in CPAC, the UE continues to maintain the connection with the source node (MN in CPAC) since CPAC is under DC. For CHO, the UE will maintain the connection with the source node as long as possible. In case the UE connection with the source is dropped before the CHO access is triggered, if at the triggering of CHO TAT is not expired, the most recent source node OWD or TA maintained at the UE can still be consider valid; otherwise, the UE maintained source node OWD or TA cannot be assumed valid and random access to the target cell should be performed.

After the conditional RRC reconfiguration message is issued, the control node continues to monitor the timing offset between the source node and the candidate nodes. If the offset change is big, the control node updates the delta timing offset to the source node and the source node send the delta offset to the UE by a MAC CE. In addition, the source node will continue to update the delta OWD or delta TA with the source node to the UE via a MAC CE.

To improve the accuracy of the source node OWD or TA to be used in UE, more strict update triggering condition would be used for a more frequently triggering of the OWD or TA update at the network.

When the conditional triggering condition is met, the UE applies the pre-configurations including static and most updated dynamic target TA assisting information to determine the target_TA. The UE locks on the target cell reference signal timing as its local reference timing for UL transmission. The UE performs it first RACH-less transmission to the target cell with the pre-granted UL resource and at a further advanced timing of target_TA over the received target cell reference signal timing.

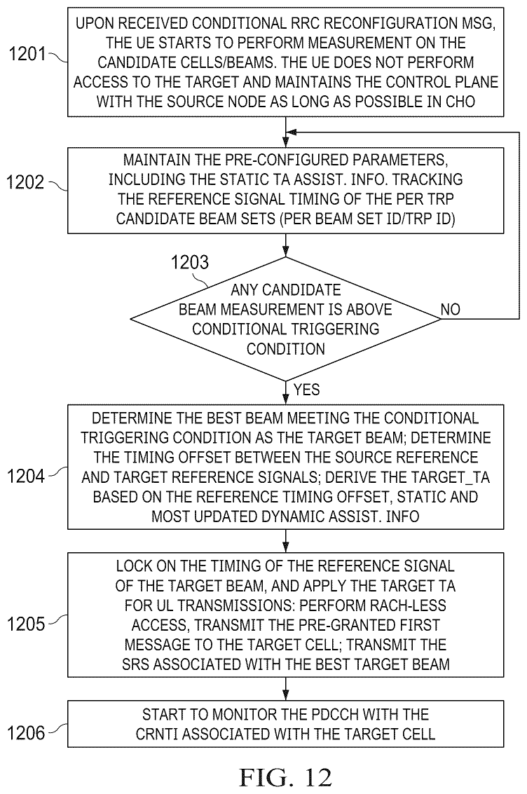

FIG. 12 shows a flow chart of the functions and procedure performed at the UE during the conditional seamless inter-cell mobility, according to some embodiments. At the operation 1201, based mobility pre-configuration, the UE performs the L1 measurement on the candidate cells/beams for conditional target access triggering.

At the operation 1202, the UE tracks the reference signal timing at a per candidate TRP beam sets basis. Using the TRP_ID which is the per TRP beam-set ID, the UE can track the timing of the strongest beam in the set for determine the timing offset of the source and target beam at the activation of target access.

At the operation 1203, the UE determines if a candidate beam measurement is above the conditional triggering condition.

If yes, at the operation 1204, upon the conditional triggering condition is met with one or more beams, the UE determines the SSB or CSI-RS of the best beam as the access target beam. The UE applies the conditional configurations including the static and the most updated dynamic target TA assistance information. The UE determines the target_TA based on the measured timing offset between the source and target beams, the static and the dynamic TA assistance information from the network.

At the operation 1205, the UE locks on the timing of the reference signal of the target beam and apply the target TA for UL transmission. The UE performs the RACH-less access to the target cell by transmit the first message to the target cell using the pre-configured UL resource. The pre-configured UL resource can be the granted resource delivered by the RRC mobility pre-configuration message. Alternatively, the grant for the first message can be instructed by the target cell PDCCH at a pre-configured timing, or the PDCCH instruction is triggered by the SRS transmission. The UE indicates the best target beam to the target cell in the first message or transmit pre-configured SRS associated with the selected target beam such that the target node is able to determine the best DL beam to be used for PDCCH and PDSCH transmission, and determine the UL receiving beam for the best reception of UL transmissions from the UE especially in FR2.

At the operation 1206, the UE starts to monitor the PDCCH with the CRTI associated with the target cell.

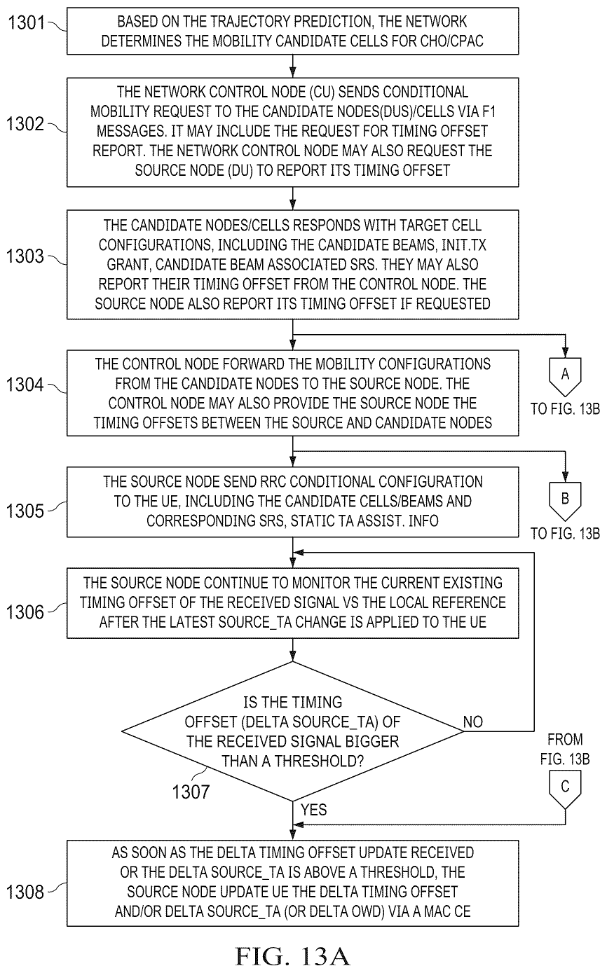

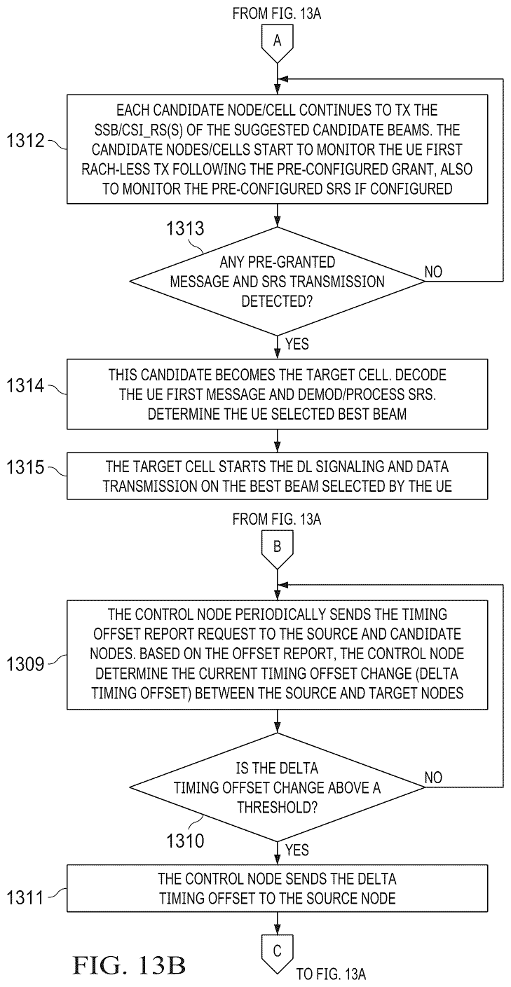

FIGS. 13A and 13B show the functions and procedure performed at the network during the conditional seamless inter-cell mobility, according to some embodiments. In the embodiments in FIGS. 13A and 13B, the network control node (which can be the mobility source node, or a MN in the DC scenario) performs the UE trajectory prediction. Based on the predicted UE trajectory and other information, the network control node determines the CHO for candidates and performs conditional pre-configuration of the candidate cells. The pre-configuration includes those for L1 measurement, TA determination and RACH-less access, and target beam selection and indication.

The network control node determines the timing offset between the source node and the target node(s) and tracks the change of the timing offset. The network control node provides the Nodes_timing_offset to the source node for conditional configuration. Afterward, whenever the timing offset change is above a threshold, the network control node updates the Nodes_delta_offset to the source node.

The source node conducts the conditional RRC configuration to the UE. The source node tracks the source OWD or TA change, whenever the change is above a threshold, and sends source delta OWD or delta TA to the UE via a MAC CE. Whenever the source node receives Nodes_delta_offset, the source node updates it to the UE via a MAC CE.

The target node provides the pre-configuration of the grant for the UE's first RACH-less transmission to the target node. The resource allocation to the initial transmission of the first message as an access notification could be conservative. The pre-granted first transmission to the target node may include the power headroom report (PHR), the buffer status report (BSR), and the best selected SSB or CSI_RS ID.

As shown in FIGS. 13A and 13B, at the operation 1301, the network control node (e.g., CU) determines the mobility candidate cells for CHO/CPAC based on the trajectory prediction.

At the operation 1302, the network control node sends the conditional mobility request to the candidate nodes (e.g., DUs)/cells via F1 messages. The conditional mobility request may include the request for timing offset report. The network control node may also request the source node (e.g., DU) to report its timing offset.

At the operation 1303, the candidate nodes/cells respond with target cell configurations, including the candidate beams, initial TX grant, candidate beam associated SRS corresponding to their current serving cell and/or potential serving cell(s). The candidate nodes/cells may also report their timing offset from the network control node. The source node also report its timing offset if requested.

At the operation 1304, the network control node forwards the mobility configurations from the candidate nodes to the source node. The network control node may also provide the source node the timing offsets between the source node and the candidate nodes.

At the operation 1305, the source node sends RRC conditional configuration to the UE. The RRC conditional configuration may include the candidate cells/beams and corresponding SRS, and the static TA assistance information.

At the operation 1306, the source node continues to monitor the current existing timing offset of the received signal vs the local reference after the latest source TA is applied to the UE.

At the operation 1307, the source node determines whether the timing offset (Delta Source_TA) of the received signal is bigger than a threshold. If yes, at the operation 1308, as soon as the delta timing offset update is received or the delta Source_TA is above a threshold, the source node updates UE the delta timing offset and/or delta Source_TA (or delta OWD) via a MAC CE.

At the operation 1309, the network control node periodically sends the timing offset report request to the source node and the candidate nodes. Based on the timing offset report, the network control node determines the current timing offset change (delta timing offset) between the source node and the target nodes.

At the operation 1310, the network control node determines whether the delta timing offset change is above a threshold. If yes, at the operation 1311, the network control node sends the delta timing offset to the source node, and the flow continues to the operation 1308 as described above.

At the operation 1312, each candidate node/cell continues to transmit the SSB/CSI_RS(s) of the suggested candidate beams. The candidate nodes/cells starts to monitor the UE's first RACH-less transmission following the pre-configured grant, and to monitor the pre-configured SRS if configured.

At the operation 1313, each candidate node/cell determines if any pre-granted message and SRS transmission is detected. If a candidate node/cell detects so, at the operation 1314, the candidate node/cell becomes the target cell, decodes the UE's first message, processes SRS, and determines the UE selected best beam.

At the operation 1315, the target cell starts the DL signaling and data transmission on the best beam selected by the UE.

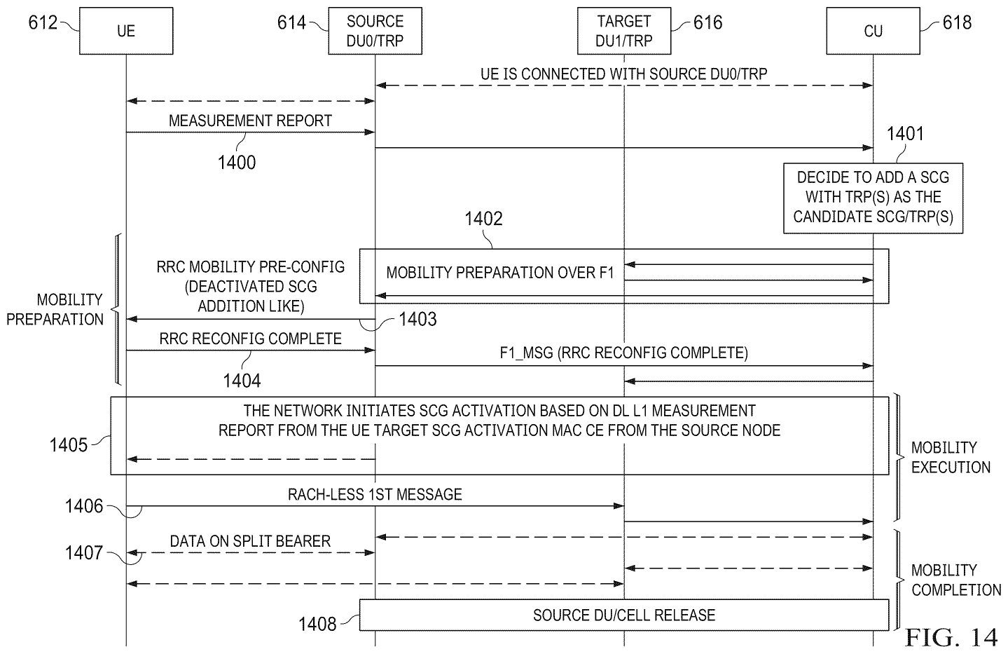

FIG. 14 illustrates the signaling flow for the suggested frame work of the seamless mobility corresponding to the mobility architecture demonstrated in FIG. 3. Operations 1400-1402 are similar to those of operations 600-602 in FIG. 6. In the scheme shown in FIG. 14, RRC mobility pre-configuration and RRC reconfiguration complete at operations 1403 and 1404 are performed early and pushed into mobility preparation phase. The delay caused by the RRC messages does not interrupt the data transmission over the UE/source node connection. The target cell access activation is triggered by MAC CE at the operation 1405. RACH-less access is performed at the operation 1406. The operation 1407 is similar to the operation 608 in FIG. 6. At the operation 1408, source DU/cell release may be performed.

The following table shows examples changes to TS 38.215 for DL reference signal time difference (DL RSTD).

| | |
|---|---|
| Definition | DL reference signal time difference (DL RSTD) is the DL relative timing |
| | difference between the Transmission Point (TP) j and the reference TP i, defined |
| | as T_{SubframeRxj} − T_{SubframeRxi}, |
| | Where: |
| | T_{SubframeRxj} is the time when the UE receives the start of one subframe from TP j. |
| | T_{SubframeRxi} is the time when the UE receives the corresponding start of one |
| | subframe from TP i that is closest in time to the subframe received from TP j. |
| | Multiple DL PRS, SSB, CSI-RS resources can be used to determine the start of |
| | one subframe from a TP. |
| | For frequency range 1, the reference point for the DL RSTD shall be the antenna |
| | connector of the UE. For frequency range 2, the reference point for the DL RSTD |
| | shall be the antenna of the UE. |
| Applicable for | RRC_CONNECTED, |
| | RRC_INACTIVE |

Changes of transmission timing adjustments to TS 38.213 are described below.

Delay_{common}(t) provides a distance at time t between the serving satellite and the uplink time synchronization reference point divided by the speed of light. The uplink time synchronization reference point is the point where DL and UL are frame aligned with an offset given by N_{TA,offset}.

If RACH-less mobility is configured, upon the mobility access to the target cell is triggered, either by the target access command in TS 38.321 or the conditional triggering condition in TS 38.331, the UE first determines the best SSB or CSI-RS as the mobility access target beam; then the UE determines the DL RSTD between the reference signals of the source TP and the target TP as specified in clause 5.1.19 of TS 38.215 with the source TP and the target TP being the TPi and TPj respectively. The UE further determines the timing advance of the target cell, Target_TA.

$$Target\_TA = 2 * DL\_RSTD + nSource\_TA + TA\_NT \_Adj \_Factor + 2 * Nodes\_delta \_offset$$

DL_RSTD is the timing offset between the source reference signal and target reference signal measured by the UE in unit of Tc in TS 38.133. DL_RSTD may also be referred to as TS_Offset in the present disclosure.

nSource_TA is converted from Source_TA which is the absolute timing advance, Absolute in TA 38.321, in the source cell. nSource_TA is in unit of Tc. At the time of target cell access is triggered, the most recent Source_TA is delivered to the UE via target cell access command MAC CE in 38.321.

TA_NT_Adj_Factor is network adjustment factor for target TA determination at the UE. It is in unit of Tc. The network sends the TA network adjustment factor to the UE by RRC mobility pre-configuration message.

Nodes_delta_offset is the change of timing offset between the source node and the target node since the RRC mobility pre-configuration message has been issued. It is in unit of Tc and can be carried by the target cell access command MAC CE.

The UE tracks the timing of the received SSB or CSI-RS of the target TRP and uses it as the reference to adjust the UL transmission timing in advance by the target TA for PUSCH/SRS/PUCCH transmission on the target cell.

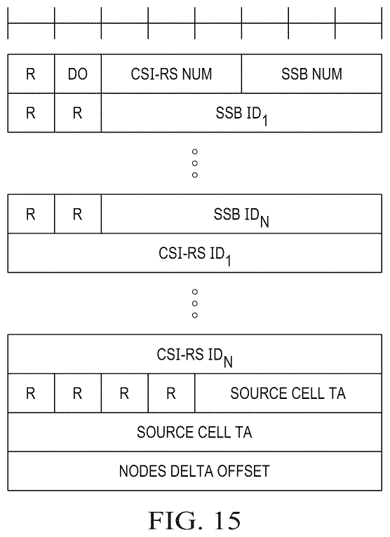

FIG. 15 shows an example Target access command MAC CE. The DO field indicates the presence of the octet containing Nodes delta offset field. The CSI-RS Num field contains the number of the CSI-RS IDs included in this MAC CE. The SSB Num field contains the number of the SSB IDs included in this MAC CE. The SSB IDi field contains the i-th SSB ID among the SSB Num of SSB IDs included in this MAC CE. The CSI-RS IDi field contains the i-th CSI-RS ID among the Num of CSI-RS IDs included in this MAC CE. The Source cell TA field is 12-bit field that contains the current Absolute TA or the TA change from the last update with the source cell. The Nodes delta offset field is an octet field that contains the delta change of the timing offset between the source node and the target node after the timing offset being configured to the UE at the time of mobility pre-configuration. The presence of this field is indicated by DO field.

If RACH-less mobility is configured, the MAC entity may, (1) if the RACH-less target cell access procedure is initiated by the reception of the target access command MAC CE defined by clause 6.1.3.x and lists of SSBs and/or CSI-RSs have been explicitly provided in the target access command and (2) if at least one SSB with SS-RSRP above rsrp-ThresholdSSB amongst the listed SSBs is available, select an SSB with SS-RSRP above rsrp-ThresholdSSB amongst the listed SSBs and transmit the SRS corresponding to the selected SSB and the first message if the its grant is pre-configured; else, if at least one CSI-RS with CSI-RSRP above rsrp-ThresholdCSI-RS amongst the CSI-RSs is available, the MAC entity may select an CSI-RS with CSI-RSRP above rsrp-ThresholdCSI-RS amongst the listed CSI-RSs and transmit the SRS corresponding to the selected CSI-RS and the first message if its grant is pre-configured.

In the mobility HO procedure, there are several steps on the time critical path of a HO that introduce large delays. RAN2 agreed the delay model and the overall time taken by L1 or L2 mobility with conventional approach. In RAN2 mobility delay model, the overall handover delay includes L1 measurement delay, DL synchronization delay, and UL synchronization delay. A long overall handover delay causes high handover failure rate and call drop rate, as well as service interruption.

After the target cell appears, it will take some time for the UE to make the L1 measurements and report them to the serving cell. Based on the measurement report, the serving cell makes the decision of a cell switch and sends the cell switch command to the UE. RAN2 considers this delay as the L1 measurement delay. The L1 measurement delay negatively impacts the handover performance. In RAN2 mobility delay model, overall handover delay includes L1 measurement delay, DL synchronization delay, and UL synchronization delay. Long overall handover delay causes high handover failure rate and call drop rate, as well as service interruption. It should be noted that the delay model discussed in RAN2 is assuming the mobility frame work based on the DL reference signal (RS) measurement (i.e., the cell switch decision is made at the source cell based on the UE DL RS measurement report).

Many schemes have been proposed for early target TA acquisition. These schemes include: (1) RACH-based solutions (e.g., PDCCH ordered RACH, UE-triggered RACH, higher layer triggered RACH from the network other than L3 HO command); (2) RACH-less solutions (e.g., SRS based TA acquisition, Rx timing difference based, RACH-less mechanism as in LTE, UE based TA measurement (including UE based TA measurement with one TAC from serving cell)).

SRS based TA acquisition is one of the candidate solutions. Different from other solutions, it can be considered as an example of UL RS based mobility if the cell switching decision made by the target cell based on UL RS measurement is allowed.

The technical issues with the UL reference signal (RS) based mobility include the UE power consumption concern. The UE needs to transmit UL RS (e.g. SRS) with high enough power and frequency to allow the target cell hear the UE. The worst scheme is that the target TA is determined at the target cell and the target cell sends the TA to the source cell. Then, the source cell, based on the L1 measurement, decides to perform a cell switch. In this case, the UEs need to transmit both SRS and L1 measurement report.

The technical issues with the UL reference signal (RS) based mobility further include the delay concern. The total delay of the UL RS based mobility includes DL measurement/beam selection and DL synchronization delay and UL measurement/synchronization delay. Since the UL timing offset at the target cell/TRP can be large, it may require a long UL RS measurement time to acquire the UL RS and obtain reliable TA. If the target cell determined target TA is sent back to the source cell, an additional backhaul delay is introduced

Due to the well-known UE power consumption and delay concerns, sending the target cell determined TA to the source cell via backhaul is not practical. The SRS based solution cannot be only for target TA acquisition. The complete UL RS based mobility that cell switch decision is made by the target cell based on the UL RS measurement deserves further study. This disclosure addresses the issues with the model/frame work of UL based mobility.

An example of known conventional UL SRS based mobility approach is as follows. For multiple candidate cells/beams, multiple SRSs are uniquely configured corresponding to each candidate cell/beam. After the pre-configuration, the UE transmits the SRSs toward all the detected candidate cells/beams. The transmission timing of each SRS should follow the timing of the reference signal of the corresponding candidate cell/TRP/beam such that the absolute TA of the target cell/TRP can be obtained directly.

The candidate/target cell, based on the received SRS of the UE, measures the absolute TA of this cell/TRP based on the UE indicated associated SSB or CSI-RS. The target cell decides the UE is close enough for a cell switch based on SRS measurements, and sends the measured TA to the UE directly in the cell switch command.

The issue with this TA determination approach is that the UE has to transmit multiple SRSs of the candidates over entire TA acquisition time in addition to SRS for its current serving cell at different transmission timing corresponding to each candidate cell/TRP. Power consumption is a big concern since the UE may need to send multiple SRSs in parallel with high power for long time. This may also occupy a lot of radio resources with additional signaling overhead.

It is to obtain the large absolute TA at the candidate DU(s) including the initial UE SRS acquisition. To obtain a reliable and accurate TA at a candidate DU in short period of time is a question. longer time for TA acquisition may be needed.

The UE needs to tune the transmission timing differently for different SRS transmission. It may increase the complexity and affect serving cell transmission with the timing for the serving cell.

Following the candidate TRPs' timing for SRS TX requires the UE to perform the DL synchronization with candidate TRPs first, SRS transmission towards candidates is later; resulting in increased HO delay.

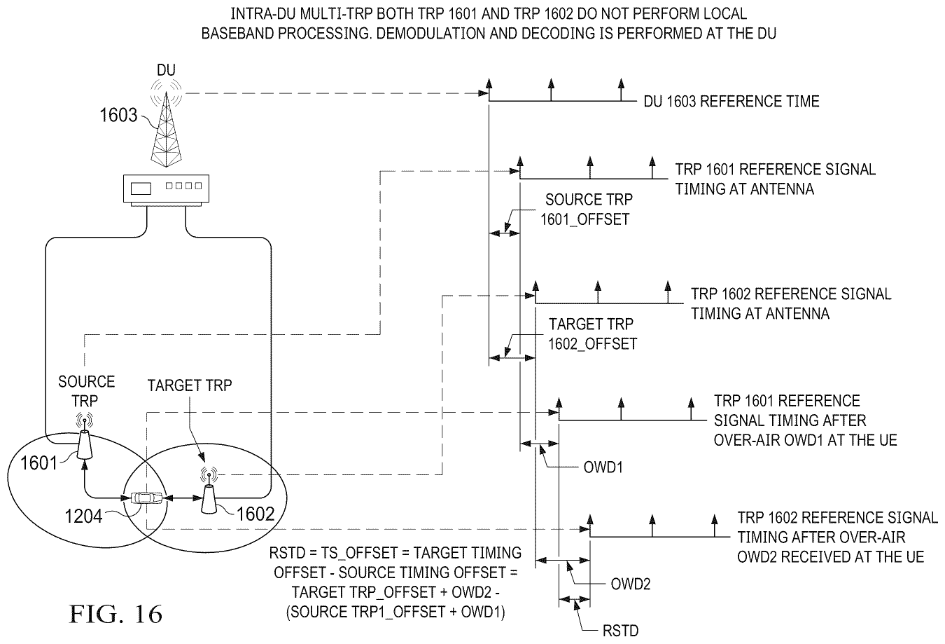

One related solution is the intra-DU multiple-TRP UL RS measurement-based TA adjustment scheme. In this scheme, the delta TA of the target TRP is determined at the serving DU which serves both the source and target TRPs. The serving DU sends the delta TA of the target TRP to the UE. After the UE acquires the DL reference signal of the target TRP, the RSTD can be measured at the UE as shown in FIG. 16.

$$RSTD = Target timing offset - source timing offset = {TargetTRP}_{2} \_Offset + {OWD}_{2} - ( {SourceTRP}_{1} \_Offset + {OWD}_{1} )$$

In the equation above, RSTD is the time offset between the source reference signal and target reference signal measured by the UE 1604. SourceTRP1_Offset is the propagation delay of the fronthaul from the DU 1603 to the source TRP 1601. OWD1 is the delay over the air interface from the source TRP 1601 to the UE 1604. TargetTRP2_Offset is the propagation delay of the fronthaul from the DU 1603 to the target TRP 1602. OWD2 is the delay over the air interface from the target TRP 1602 to the UE 1604.

When the UE 1604 performs UL TX using target TRP reference signal timing as its reference for UL transmission, the adjusted delta TA should be used, and the UE 1604 makes the adjustment with the latest measured RSTD.

$$Adjusted\_TargetdeltaTA = SourceRef\_DeltaTargetTA + RSTD$$

In the above equation, RSTD for mobility is defined as RSTD=target TRP reference signal timing-source TRP reference signal timing, which is measured at the UE 1604. SourceRef_DeltaTargetTA is the delta TA the serving DU 1603 measured on the SRS with the source timing. It is sent via a TAC including a TAGID associated with the target beam of the target TRP 1602.

The solution may be extended to the inter-DU multiple TRP scenarios.

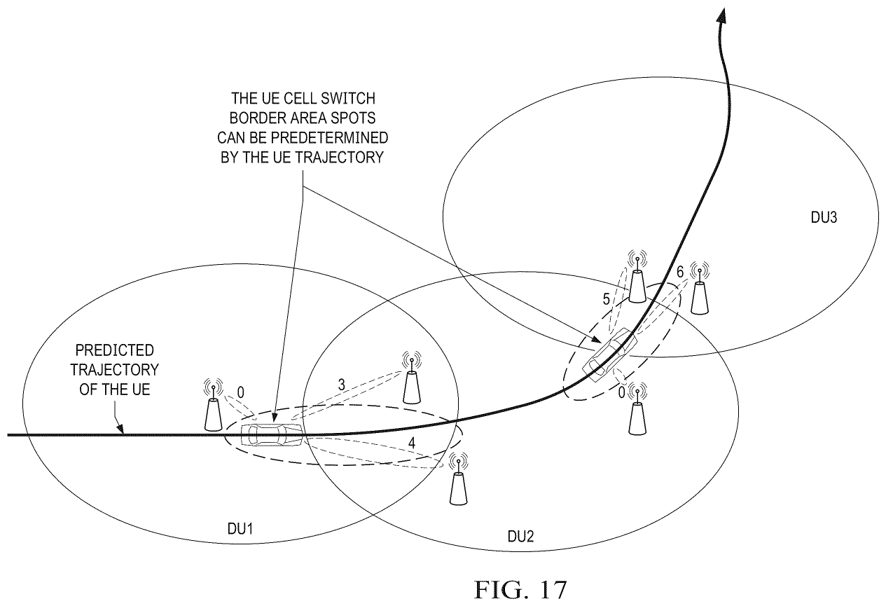

With travel planning applications (e.g., Google Maps) and more Full Self-Driving (FSD) devices being in use, in a lot of cases, the UE traveling trajectory is pre-scheduled and pre-determined. In those cases, the UE trajectory can be considered as deterministic or semi-deterministic, which may be updated over some time by the UE or at the network. With the assumption of the UE semi-deterministic trajectory information is available at the network, it can be used for L1/L2 multi-candidate pre-configuration. FIG. 17 shows network determined source and candidate beams based on the UE trajectory. The UE mobility border area spots of the candidate cells on the trajectory can be determined by the network. Based on the locations of the border spots and the locations of the TRPs of the source and target cells neighboring to the border spots, the serving beam(s) and the candidate beam(s) for the UE at the border spots can be pre-determined, and therefore the UE receiving beam sweeping pattern associated with the serving and the candidate beams.

Since the mobility pre-configuration for mobility is based on not only the measurement, but also other information (e.g., UE trajectory), when the UE performs the subsequent cell switches from a new serving source cell to the subsequent candidate cell, initial candidate beam search and acquisition may be required. Normally, initial candidate beam searching with exhaustive beam sweeping can take long time to acquire a candidate beam. It is desirable to reduce the initial beam searching time to support the fast cell switch in L1/L2 mobility by instructing the UE only to perform the beam search and measurement on the candidate beams of the current serving cell. Furthermore, the UE can be instructed to perform initial beam search on the candidate beams associated with the current serving beam. Searching and measuring all the candidate beams of all the candidate cells pre-configured can be avoided to save UE power and reduce measurement delay.

In L1/L2 mobility, the L1 measure and beam selection delay is one of the major delay components. As explained above, in a multi-beam-forming enabled system, initial beam selection and acquisition via receiving beam sweeping operation is time consuming. In this disclosure, a pre-configured beam sweeping pattern is introduced to reduce the time for initial beam acquisition. The present disclosure discloses how the beam pattern is determined and how the beam sweeping pattern can be practically used by the UE.

For the known conventional UL RS based mobility schemes, there are concerns on large UE power consumption and high signaling overhead.

This disclosure describes a UL RS based mobility scheme which minimizes the delay on the time critical path of the HO procedure, works for both synchronized and asynchronized network, and overcomes the large UE power consumption, large radio resource occupation, large signal overhead and low reliability issues with the conventional UL RS based mobility schemes.

In order to reduce the L1 measurement delay for L1/L2 mobility, a method of pre-configuring the UE receiving (RX) beam sweeping pattern is introduced. Based on the UE trajectory prediction, the relative positions of the source serving beam(s) and candidate target beam(s) may be pre-determined. The UE beam sweeping pattern using the serving source beam as a reference may be determined and configured to the UE by RRC configuration. After the pre-configuration at the border area, the UE only needs to follow the beam sweeping pattern to perform the initial candidate beam search.

In order to resolve the UE power consumption and radio resource usage concern on UL RS based mobility, and minimize the target access delay, this disclosure describes a two stage SRS transmission scheme for target TA acquisition for inter DU/cell handover as follows.

At mobility preparation phase, the CU informs the candidate DU(s) the configuration of SRS(s) used by the UE with the source DU/cell(s).

By pre-configuration, the SRS(s) corresponding to candidate SSB(s)/CSI-RS(s) are configured to the UE.

The embodiment techniques allow early SRS transmission towards candidate cell/TRP/beam(s) with low additional power consumption. If a received candidate SSB or CSI-RS is strong enough (above a threshold), the UE continues to transmit the SRS for its current serving cell with possibly reduced periodicity and consecutive repetition configured for mobility, and at the timing of the received serving source cell reference signal+source_TA.

After DL synchronization with a candidate beam is achieved and high-quality target SSB/CSI-RS criterion is met, the UE transmits SRS pre-configured corresponding to the synchronized candidate beam with the periodicity configured for mobility, and at the timing of the received serving cell reference signal+source_TA.

The candidate/target DU, based on the serving SRS configuration, performs an initial search the UE SRS including receiving beam sweeping through expected receiving beams and TRPs, wide search window for big timing offset. The candidate DU measures the timing offsets of the target beam associated SRS received from the candidate TRP of the candidate DU/cells. If the received SRS strength is above a threshold, the candidate/target DU considers the measured timing offset as the TA of the target cell/TRP/beam, and issues the cell switch command to the UE including the measured TA.

The target DU determined delta TA for the target cell/TRP/beam is the measured delta timing offset of the received SRS, which is transmitted by the UE at the source RS timing (denoted as SourceRef_DeltaTargetTA).

The UE adjusts the timing for UL transmission to the target cell with the target beam reference signal timing in inter DU/cell handover scenario.

$$Adjusted\_DeltaTargetTA = SourceRef\_DeltaTargetTA + RSTD$$

The making and using of embodiments of this disclosure are discussed in detail below. It should be appreciated, however, that the present disclosure provides many applicable inventive concepts that can be embodied in a wide variety of specific contexts. The specific embodiments discussed are merely illustrative of specific ways to make and use the present disclosure, and do not limit the scope of the disclosure. These and other inventive aspects are described in greater detail below. The present disclosure provides a generic method for applications with very high reliability, low latency and delay requirements, especially for the mobility applications in the areas of MBB and V2X. The method very reliable, accurate and efficient to minimize the delay due to mobility comparing with various prior art. It may be used in different systems such as NR, LTE.

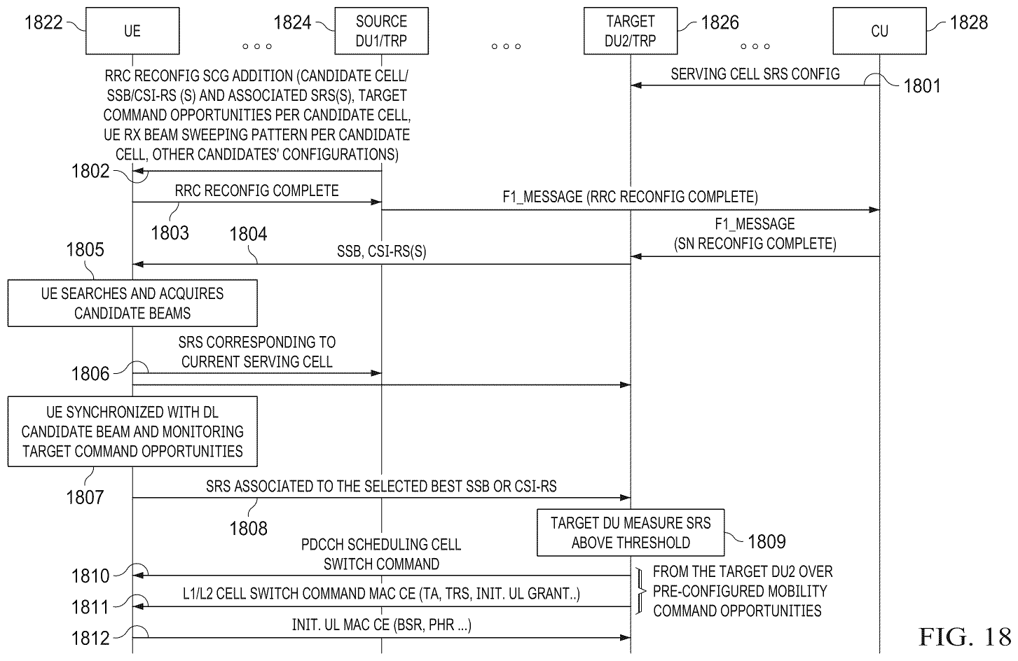

FIG. 18 illustrates an example of UL RS based mobility framework with impacts to both the air interface and the network interface. At the operation 1801, at the mobility preparation phase, through the CU 1828, the source DU 1824 informs the candidate DU(s) 1826 the configuration of SRS(s) which the UE 1822 is used with the serving source DU/cell(s) 1824.

At the operation 1802, by pre-configuration, the SRS(s) corresponding to target SSB(s)/CSI-RS(s) and RX beam sweeping pattern are configured to the UE 1822.

At the operation 1803, after the RRC pre-configuration is received, the UE sends RRC configuration complete message back to the source DU/cell(s) 1824. The source DU 1824 relays the message to the CU 1828, and the CU 1828 notifies the candidate DU/cell(s) 1824 at the operations 1803.1 and 1803.2.

At the operation 1804, upon receiving the RRC configuration complete notification, the candidate cell 1826 starts to transmit the DL reference signals configured for the UE 1822 if any.

At the operation 1805, upon reception of RRC Reconfiguration message for L1/L2 mobility, the UE 1822 starts to perform search and measurement on the SSB(s) and CSI-RS(s) of the candidate cells/TRPs. Based on the pre-configured RX beam sweeping pattern to search the candidate SSB(s) and CSI-RS(s).

At the operation 1806, when a received candidate SSB or CSI-RS is strong enough (above a threshold), the UE 1822 starts, for FR1, to continue the transmission of the SRS for its current serving cell with the periodicity and repetition configured for mobility, and at the timing of the received serving cell reference signal+source_TA. For FR2, the UE 1822 starts to tune the UL TX beam towards the target cell with a power based on the received power of SSB or CSI-RS of the target cell, and on the beam to transmit the SRS of its current serving cell with the periodicity configured for mobility, and at the timing of the received serving cell reference signal+source_TA,

At the operation 1807, if the SSB(s) or CSI_RS(s) strong enough and stable, the UE 1822 performs DL synchronization operations with them. The UE 1822 acquires and stores their timing (e.g., RSTD) or the candidate SSB or CSI-RS's timing offset from the UE local reference timing, and other synchronization information from the broadcast channel (BCH), and starts to tracking their timing information by measuring, reading, and updating the stored DL synchronization information of the tracked SSB(s) and CSI-RS(s) periodically. The UE 1822 starts to monitor the periodic cell switch command monitoring opportunities pre-configured.

At the operation 1808, upon the UE 1822 acquiring DL synchronization with a candidate SSB or CSI-RS whose quality is above a threshold, the UE 1822 transmits pre-configured SRS corresponding to the synchronized candidate SSB or CSI-RS with the periodicity configured for mobility, and at the timing of the received serving cell reference signal+Source_TA. In case of FR2, a beam tuning to the target cell is used to transmit the SRS with a power determined by the received power of the synchronized candidate SSB or CSI-RS.

At the operation 1809, after the reception of the RRC Configuration Complete message, the candidate DU based on the serving SRS configuration performs initial search of the UE SRS including receiving beam sweeping through expected receiving beams and TRPs, wide search window for big timing offset. The candidate DU also starts to monitor the SRSs configured to the UE associated with the candidate beams.

At the operation 1810-1811, when a candidate DU received SRS indicating that the UE is selected a good SSB/CSI-RS and synchronized with it, and the SRS measurement is meeting the cell switch triggering criterion, the target DU 1826 based on the received SRS determines the corresponding target SSB or CSI-RS. The target DU 1826 measures the timing offset from the received SRS and determine the TA (=SourceRef_DeltaTargetTA). The target DU 1826 schedules the cell switch command MAC CE via PDCCH on the target beam and transmits the MAC CE to the UE 1822 over the pre-configured monitoring opportunities. The MAC CE carries the target DU measured delta TA

At the operation 1812, after the UE 1822 receives the cell switch command MAC CE, the UE 1822 transmits the first UL MAC CE which may contain BSR, PHR to the target DU 1826 with the following adjusted delta timing advance:

$$Adjusted\_DeltaTargetTA = SourceRef\_deltaTargetTA + RSTD$$

If the UE 1822 received more than one cell switching command from multiple candidate DUs, the UE 1822 selects one as the target DU 1826 and sends acknowledgement to it, and sends “rejection” or “pending” notification(s) to the other switching triggered DU(s).

In order to resolve the UE power consumption and radio resource usage concern on UL RS based mobility, and minimize the target access delay, this disclosure provides the embodiment two stage SRS transmission scheme.

At mobility preparation phase, the source DU informs the candidate DU(s) the configuration of SRS(s) used by the UE at the source DU/cell(s). This allows the candidate DU(s) to be able to detect the SRS that the UE is using for the current source serving cell.

By pre-configuration, the SRS(s) corresponding to candidate target SSB(s)/CSI-RS(s) and the SRS(s) corresponding to the serving SSB(s) and CSI-RS(s) for the candidate cells are configured to the UE. The candidate target and source SSB(s) and CSI-RS(s), and their associated SRS(s) are associated with a corresponding candidate DU (d)/cell(s) for the subsequent cell switch when the candidate cell becomes the new source cell. Their configurations are prepared by each candidate DU.

Currently, the SRS length is 1 to 4 symbols. The short RACH preamble length is 2 to 12 symbols. Enhancements on SRS for UL RS based mobility may be added including, for example, that longer SRSs can be defined for mobility purpose. At the first stage of SRS transmission for mobility, shorter periodicity and consecutive repetition of current regular SRS symbols may be allowed.

The two stage SRS transmission is described for UE power saving and efficient UL synchronization.

For the first stage, after the pre-configuration, the UE performs beam search and L1 measurement for the candidate beams. If a candidate beam is strong enough (above a threshold), the UE continues to transmit the SRS for its current serving cell, but possibly with the shorter periodicity and current SRS symbol repetition configured for mobility. The timing of the SRS transmission maintains the same as the timing of received serving cell reference signal+Source_TA. In case of FR2, a beam tuning to the target cell is used to transmit the SRS with a power determined by the received power of the candidate SSB or CSI-RS.

For the second stage, upon the UE acquiring DL synchronization with a candidate SSB or CSI-RS whose quality is above a threshold, the UE considers the SSB or CSI-RS as the likely target reference signal and transmits pre-configured SRS corresponding to the UE synchronized candidate SSB or CSI-RS with the periodicity configured for mobility. The SRS transmission is at the timing of the UE received serving cell reference signal+Source_TA.

In case of FR2, a beam tuning to the target cell is used to transmit the SRS with a power determined by the received power of the UE synchronized candidate SSB or CSI-RS.

The SRS is used to indicates the UE selected DL beam, indicate UE synchronized with the selected beam, and facilitate the final UL synchronization to get accurate and stable TA measurement.

The candidate/target DU, based on the serving SRS configuration, performs initial search the UE SRS including receiving beam sweeping through expected receiving beams and TRPs, wide search window for big timing offset.

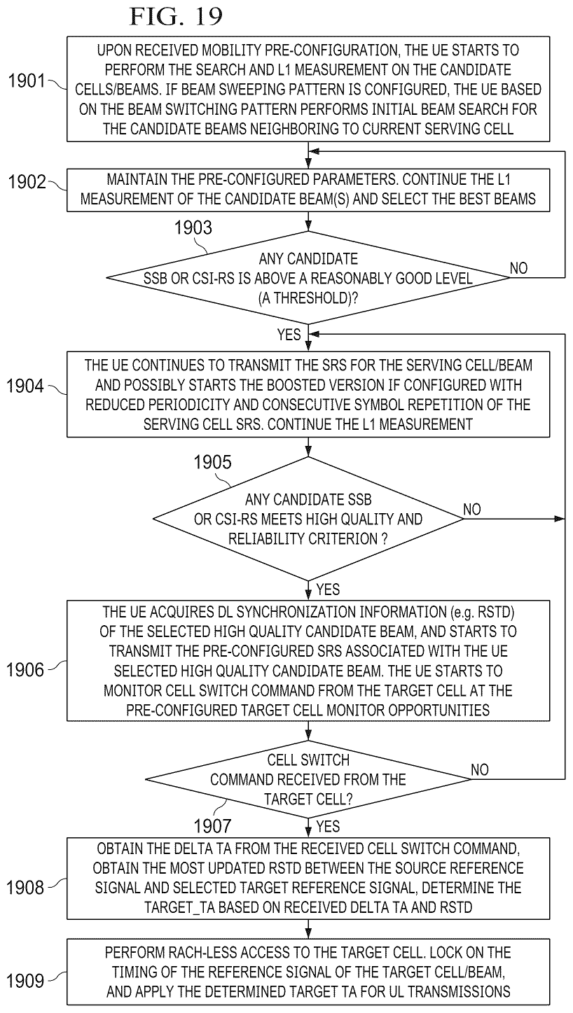

FIG. 19 shows the functions and procedure performed at the UE during the UL RS based inter-cell HO. At the operation 1901, based on mobility pre-configuration, if required, the UE performs initial search and acquisition of the candidate cells/TRPs/beams, and performs the L1 measurement on the acquired candidate beams. If beam sweeping pattern is configured, the UE based on the beam switching pattern performs initial beam search for the candidate beams neighboring to current serving cell.

At the operation 1902, the UE maintains the pre-configuration parameters, continues the L1 measurement pf the candidate beam(s) and selects the best beam(s).

At the operation 1903, the UE determines whether there is any candidate SSB or CSI-RS strength above a reasonably good level (a threshold). If yes, at the operation 1904, the UE continue to perform the existing serving cell SRS transmission, and possibly starts the boosted version (if configured) with reduced periodicity and consecutive symbol repetition of the serving cell SRS.

At the operation 1905, the UE determines whether there is a candidate SSB or CSI-RS meets high quality and reliability criterion. If yes, at the operation 1906, the UE acquires DL synchronization information (e.g. RSTD) of the selected high quality candidate beam, and the UE starts to transmit the pre-configured SRS associated with the UE selected high quality candidate beam at the timing of the received serving source cell reference signal plus the source cell TA. The UE starts to monitor cell switch command from the target cell at the pre-configured target cell monitor opportunities.

At the operation 1907, the UE determines whether a cell switch command is received from the target cell. If yes, at the operation 1908, upon receiving the cell switch command, the UE obtains the delta TA from the received cell switch command. The UE obtains the most updated RSTD between the source reference signal and selected target reference signal. The UE determines the DeltaTargetTA based on received delta TA measured by the target DU and RSTD.

At the operation 1909, the UE locks on the timing of the reference signal of the target cell/beam, applies the determined target TA for UL transmissions, performs the RACH-less access to the target cell, and starts data transmission.

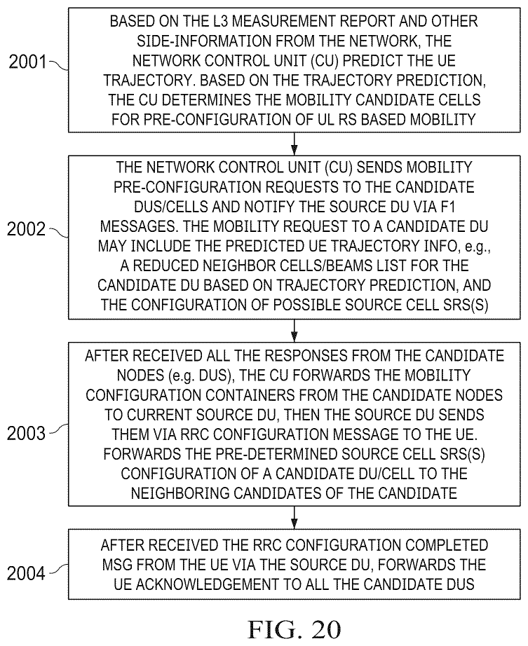

FIG. 20 shows the functions and procedure performed at the CU during the UL RS based inter-cell HO, according to some embodiments. At the operation 2001. The network CU performs UE trajectory prediction. Based on the L3 measurement report and other side-information from the network, the CU predicts the UE trajectory. Based on the trajectory prediction, the CU determines the mobility candidate cells for pre-configuration of UL RS based mobility.

At the operation 2002, based on the UE L3 measurement report, other side information, and UE trajectory prediction, the CU sends mobility pre-configuration requests to the candidate DUs/cells and notifies the source DU via F1 messages. The mobility request to a candidate DU may include the predicted UE trajectory-based information, e.g., a reduced neighbor cells/beams list for the candidate DU based on trajectory prediction, and the configuration of possible source cell SRS(s).

At the operation 2003, after receiving all the responses from the candidate nodes (e.g. DUs), the CU forwards the mobility configuration containers from the candidate nodes to current source DU, and then the source DU sends them via RRC configuration message to the UE. The CU forwards the pre-determined source cell SRS(s) configuration of a candidate DU/cell to the neighboring candidates of the candidate.

At the operation 2004, after receiving the RRC configuration completed message from the UE via the source DU, the CU forwards the UE acknowledgement to all the candidate DUs.

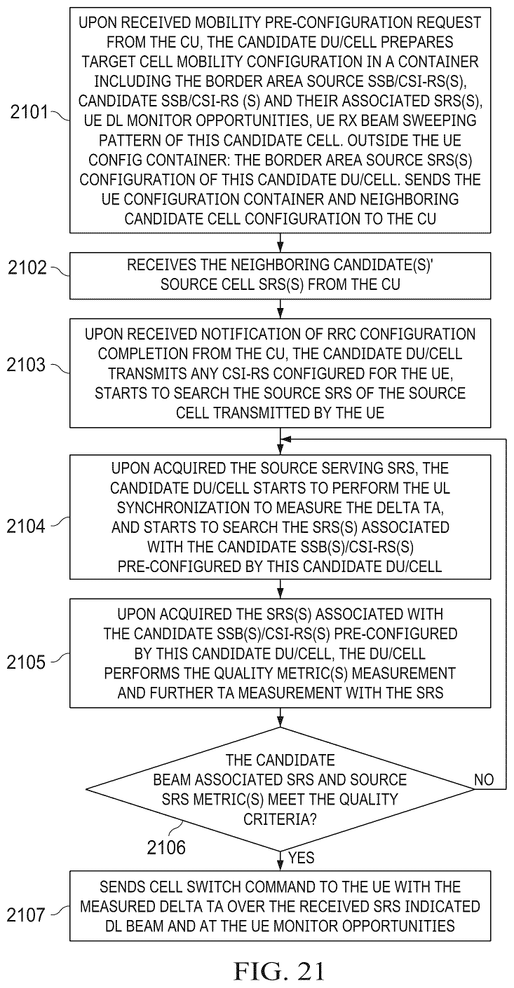

FIG. 21 shows the functions and procedure performed at a candidate DU/cell during the UL RS based inter-cell HO. At the operation 2101, upon receiving a mobility pre-configuration request from the CU, the candidate DU/cell prepares target cell mobility configuration for the UE, and sends the UE configuration container and neighboring candidate cell configuration to the CU.

The mobility configuration may include, in a UE configuration container, on top of the conventional mobility configuration, the border area source cell serving SSB/CSI-RS(s), candidate SSB/CSI-RS(s) and their associated SRS(s), UE DL monitor opportunities, and UE RX beam sweeping pattern of this candidate cell.

The mobility configuration may further include, outside the UE config container, the border area source cell serving SRS(s) configuration of this candidate DU/Cell. This configuration facilitates the neighboring candidate DU/cell to search and acquire the source cell serving SRS when this candidate DU/cell becomes a source DU/cell.

At the operation 2102, the candidate DU/cell receives the neighboring candidate(s)′ source cell SRS(s) from the CU. Based on the UE trajectory prediction, some neighboring candidate DU/cell(s) to this candidate DU/cell may be become the source DU/cell with associated source SRS(s) at the cell border area. The configuration of potential source serving SRS of the neighboring candidate DU/cell(s) is relayed to this reference candidate DU/cell by the CU.

At the operation 2103, upon receiving notification of RRC configuration completion from the CU, the candidate DU/cell transmits any CSI-RS configured for the UE, and starts to search the source SRS of the source cell transmitted by the UE.

At the operation 2104, upon acquiring the source serving SRS, the candidate DU/cell starts to perform initial UL synchronization to measure the delta TA relative to the local reference time, and starts to search the SRS(s) associated with the candidate SSB(s)/CSI-RS(s) pre-configured by this candidate DU/cell.

At the operation 2105, upon acquiring the SRS(s) associated with the candidate SSB(s)/CSI-RS(s) pre-configured by this candidate DU/cell, the DU/cell performs the quality metric(s) measurement and further TA measurement with the SRS. This SRS indicates to the candidate DU/cell that the UE considers the SRS associated beam (SSB or CSI-RS) good to be a target beam and the UE already acquired the synchronization of the beam.

At the operation 2106, the candidate DU/cell determines whether one received candidate beam associated SRS quality metric and also possibly the received source SRS metric meet the cell switch quality criteria. If yes, at the operation 2107, the candidate DU/cell considers itself to be a target DU/cell for mobility. It sends cell switch command to the UE carrying the measured delta TA over the DL beam indicated by the SRS, and at the UE monitoring opportunities.

The above embodiment technique reduces UE power consumption and the delay of the UL RS based mobility. The embodiment technique allows the seamless UL RS based mobility with minimal service interruption and high data throughput during intercell handover. The embodiment technique also overcomes the issues of large UE power consumption, large radio resource occupation, large signal overhead and low reliability issues with known UL RS based mobility schemes.

This disclosure provides more accurate and reliable fast TA determination method at the target DU/cell for both synchronized and asynchronized network. It allows the RACH-less access in most common mobility scenarios.

In the embodiment solution, the SRS transmission timing is Source Reference Signal timing+Source_TA and the target DU determined timing offset of the target cell/TRP is the measured delta timing offset (delta TA) of the SRS with the source TX timing (denoted as SourceRef_DeltaTargetTA). The target DU measured delta TA can be a positive or negative value—indicates timing advance or delay relative to current UE transmission timing.

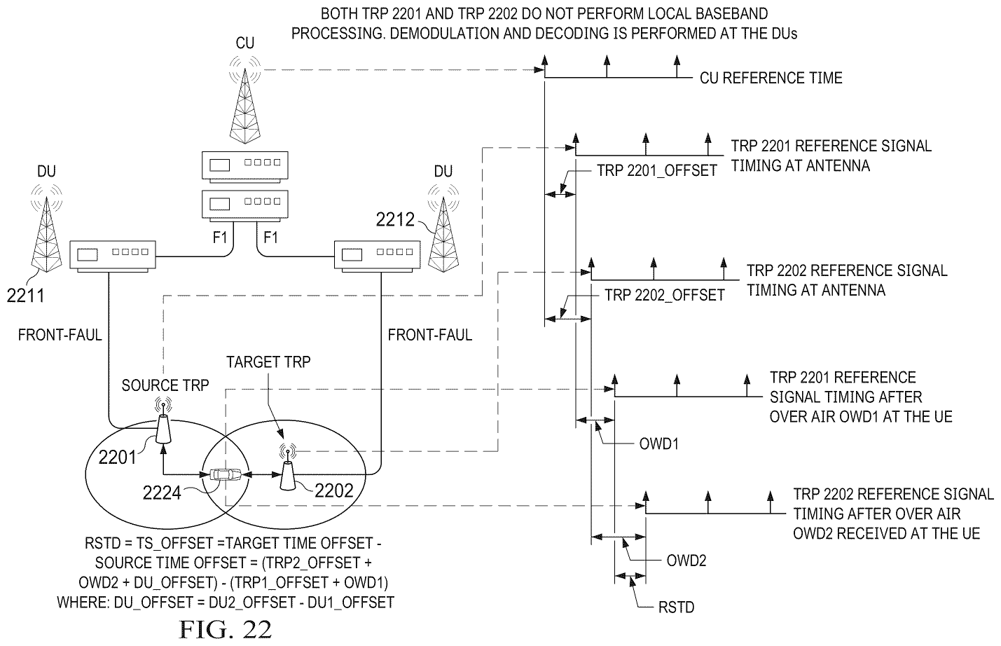

FIG. 22 illustrates an example that the UE 2224 initially uses the received reference signal from the source TRP 2201 as its local reference for transmitting its SRS, the source DU 2211 determined TA for the source TRP 2201, SourceTRP1_TA, is below.

$${SourceTRP}_{1} \_TA = 2 * ( {SourceTRP}_{1} \_Offset + {OWD}_{1} ) \qquad ( 11 )$$

OWD1 is the delay over the air interface from the Source TRP 2201 to the UE. There is a timing offset between the source DU 2211 and the target DU 2212 as below.

$$DU\_offset = {TargetDU}_{2} \_offset - {SourceDU}_{1} \_offset$$

Taking the source DU 2211 timing as the reference, Du_offset=TargetDU2_offset is the Target DU 2212 timing offset relative to the source DU 2211 local reference timing.

Taking the source DU1 timing as the reference, Du_offset=TargetDU2_offset is the Target DU 2212 timing offset relative to the source DU 2211 local reference timing.

The target DU 2212 measured receiving UL RS timing offset is the delta TA for target TRP 2202 with TRP 2201 reference signal as UE local reference plus the source TA as the UL RS transmission timing, which is denoted as SourceRef_DeltaTargetTA below.

$$SourceRef\_DeltaTargetTA = ( {SourceTRP}_{1} \_Offset + {OWD}_{1} ) + ( {TargetTRP}_{2} \_Offset + {OWD}_{2} ) - {SourceTRP}_{1} \_TA - DU\_offset \qquad ( 12 )$$

TargetTRP2_Offset is the propagation delay of the fronthaul from the target DU 2212 to the TRP 2202. OWD2 is the delay over the air interface from the TRP 2202 to the UE 2224. SourceTRP1_TA is the timing advance the UE 2224 currently using with the source cell/TRP 2201. DU_offset is timing offset of the target DU 2212 relative to the source DU 2211. It has minus sign in equation (12) since the target TA is measured at the target DU 2212 with DU 2212's local time as the reference.

The SourceRef_DeltaTargetTA is the delta target TA that the target DU 2212 measured on the UL RS received through the target TRP 2202 of the DU 2212 before the cell switch. From the equation (12), it is shown that the source DU 2211 and target DU 2212 timing offset, DU_offset, and the source cell TA, SourceTRP1_TA, are already included in the delta target TA measurement at the target DU 2212. When the target DU 2212 decides the cell switch and sends the cell switch command including SourceRef_DeltaTargetTA to the UE 2224, the UE 2224 upon receiving the command switches its local timing reference to the target TRP 2202 reference signal for its UL transmission to the target cell/TRP 2202, the new TargetTRP2_TA is below.

$${TargetTRP}_{2} \_TA = 2 * ( {TargetTRP}_{2} \_Offset + {OWD}_{2} ) \qquad ( 13 )$$

With equations (12) and (13), equation (14) follows below.

$$( {TargetTRP}_{2} \_Offset + {OWD}_{2} ) - ( {SourceTRP}_{1} \_Offset + {OWD}_{1} ) + DU\_offset \qquad ( 14 )$$

The timing difference between the DL reference signals from the source cell/TRP 2201 and the target cell/TRP 2202 is RSTD.

$$RSTD = ( {TargetTRP}_{2} \_Offset + {OWD}_{2} + DU\_offset ) - ( {SourceTRP}_{1} \_Offset + {OWD}_{1} ) \qquad ( 15 )$$

Equation (15) also shows that the UE measured RSTD also includes DU_offset. Since the network introduced timing offset is already measured by the target DU 2212 and the UE 2224, in this approach, there is no need to configure a network adjusting factor to compensate the DU_offset.

Then, at the cell switch, the UE 2224 could obtain its new TA to the target TRP 2212 by adjusting the delta TA received from the cell switch command. The new TRP2_TA can be obtained by adjusting the received SourceRef_DeltaTargetTA with RSTD.

$${TargetTRP}_{2} \_TA = SourceRef\_DeltaTargetTA + {SourceTRP}_{1} \_TA + RSTD \qquad ( 16 )$$

TargetTRP2_TA is the absolute TA for UL transmission to the target cell/TRP 2202. Upon received SourceRef_DeltaTargetTA with the cell switch command, the UE 2224 can apply an adjusted delta TA on top of the current TA in use of the source cell/TRP 2201, SourceTRP1_TA, for UL transmission to the target cell.

$$Adjusted\_DeltaTargetTA = SourceRef\_DeltaTargetTA + RSTD \qquad ( 7 )$$

The cell switch command is sent from the target DU 2212/TRP 2202 over the DL beam which has been selected by the UE and indicated to the target DU 2212.

The above embodiment technique describes how to adjust the delta TA measured at the target node (e.g., the target DU 2212) based on the received UL signal whose transmission timing is the UE locked source cell reference signal timing. After the cell switch, the UE needs to adjust the received delta TA from the target DU with RSTD, then apply the adjust delta target TA for UL transmission.

The above embodiment technique provides a generic method to adjust the delta TA received from the target DU/cell if the UE transmits UL signal following the source cell reference timing for TA acquisition at the target DU/cell. The UL signal can be the preamble(s) of RACH based TA solution, or the SRS(s) of the SRS based TA acquisition, or other UL signals of other TA acquisition methods.

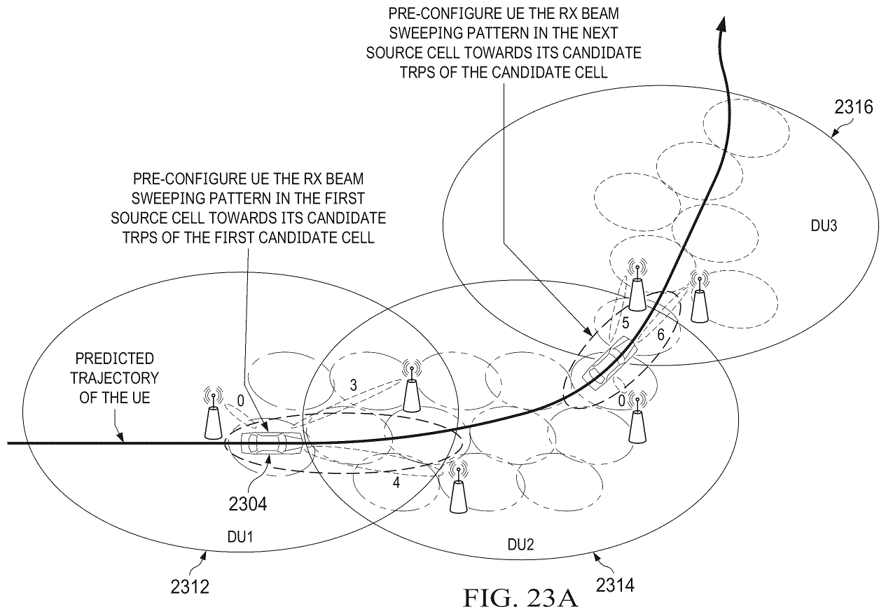

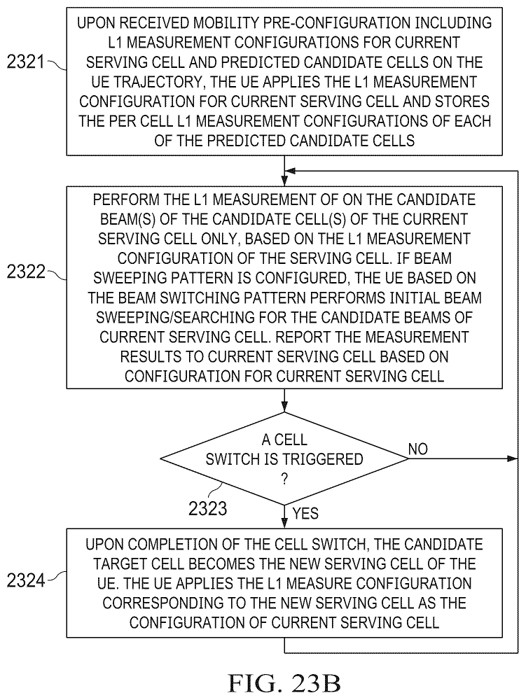

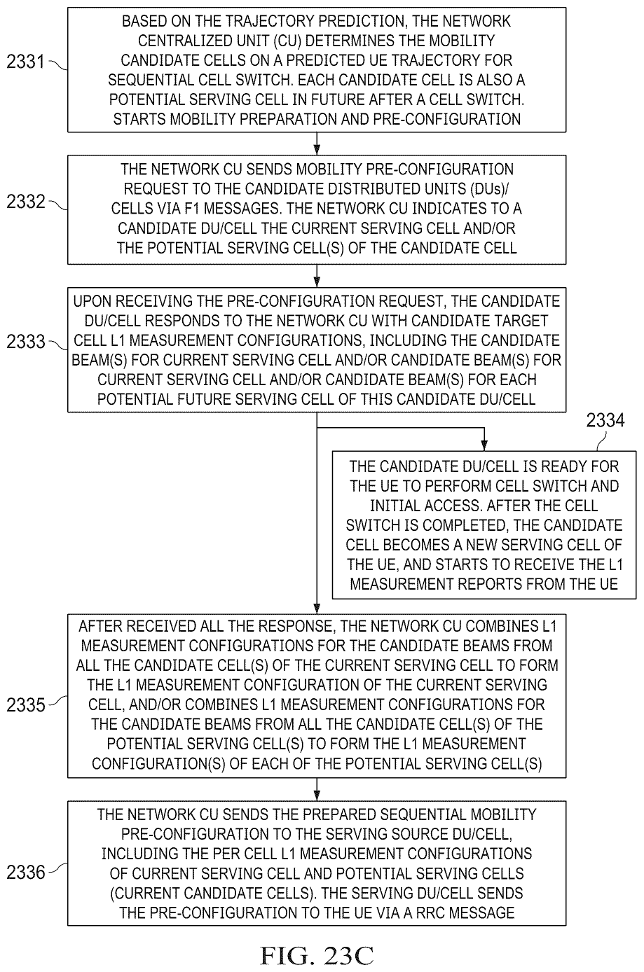

In another embodiment, to reduce the L1 measurement delay, in high frequency scenarios (e.g. FR2), the UE RX beam sweeping pattern can be pre-configured to the UE based on the UE trajectory prediction. As shown in FIG. 23A, based on the beam sweeping pattern that the network suggested for the current serving source cell 2312, the UE 2304 performs an initial search for the candidate beams predicted for the current source cell 2312.

RAN2 already agreed that the mobility RRC pre-configuration is used to configure multiple candidate cells, and the subsequent cell switches among the candidate cells can be conducted without additional RRC configuration. Currently, the mobility configuration only considers to configure the candidate cell/beams to the UE (e.g., the UE 2304). In L1/L2 sequential cell switches, cell role changes occur (i.e., a candidate cell can change to a source cell and a source cell can change to a candidate cell). In order to support the subsequent cell switches, the RRC pre-configuration can consider the role change of a candidate cell to the source serving cell. The cells on the UE 2304's trajectory are configured to serve the role of a candidate cell and the role of a serving source cell. For example, the candidate beams, the serving beams and associated configurations may be configured for the cell in a role of a serving source cell.

In order to support per current serving cell based L1 measurement after a cell switch and role change, in the mobility preparation and pre-configuration phase, the network CU indicates in the F1 mobility request message to a candidate cell its current serving cell and/or potential serving cell(s). Upon receiving the identity(es) of serving cell and/or potential serving cell(s) from the CU, the candidate cell reports to the CU, the candidate beams and related L1 measurement configuration corresponding to current serving cell and/or each of potential serving cell(s). Based on the reports from all the notified candidate cells, the CU combines all the received L1 measurement configurations of the candidate beam(s) of all the candidate cell(s) for current serving cell to form the L1 measurement configurations of the current serving cell. Similarly, the CU combines the L1 measurement configurations of the candidate beam(s) of all the candidate cell(s) for each potential serving cell, which is currently a mobility candidate cell on the UE trajectory, to form the L1 measurement configurations of each of current candidate cell(s). Furthermore, the CU based on the predicted UE trajectory determines the beam sweeping pattern of candidate beam(s) of the candidate cell(s) associated with a potential serving beam of the current serving cell and/or a potential serving beam of potential serving cell(s) after a role change.

In this particular case, with the initial RRC pre-configuration, the UE mobility RX beam sweeping patterns are configured for a current source cell (e.g., the cell 2312) and every candidate cell (e.g., the cell 2314 and/or the cell 2316) at a per cell basis. The RX beam sweeping pattern of a cell is only used/applied by the UE when the cell is currently a source serving cell. That is, the pre-configured beam sweeping pattern of a candidate cell is only applied at the UE when the candidate cell becomes the new serving source cell.

The beam sweeping pattern can be associated to the serving beam(s) at the mobility border area and pre-configured to the UE. In current legacy mobility configuration, only the candidate cell(s)/beam(s) are pre-configured to the UE. With the embodiment technique in this disclosure, both the candidate beam(s) and the serving beam(s) are pre-configured to the UE for each pre-configured candidate cell. The serving beam(s) and candidate beam(s) of a specific candidate cell are used for the UE to perform subsequent cell switch when this candidate cell becomes the new serving source cell. The association of the serving beam(s) and the candidate beams with the cell switch pattern can be defined and configured to the UE.

For example, the RX beam pattern takes the current serving beam as the reference and is numbered (e.g., as beam o in the cell 2312), and the rest beams are numbered clockwise (e.g., 1-7 for a UE has 8 beams). If there is only one possible serving beam, then as shown in FIG. 23A, the sweeping pattern could be indexed by [3, 4] relative to the serving beam o. The mobility serving beam ID (of SSB or CSI-RS) can be associated with beam o and pre-configured to the UE.

If there are more than one serving beams, the one with high probability of being used at HO can be assigned as beam o. The other one, e.g. based on relative location of the beam, could be assigned a number 3. Based on the candidate beam location, relative to beam o in the cell 2316, the sweeping pattern is beams indexed by [5, 6] in the cell 2316.

If the serving beam (ID) is the one corresponding to beam o, the UE may perform beam sweeping to the beams indexed by [5, 6] clockwise relative to beam o,

If the serving beam is the one corresponding to beam 3, the UE may perform beam sweeping [5, 6] clockwise relative to beam 3.

The example of horizontal UE receiving beams used here is for demonstrating the embodiment method. The embodiment method of using current serving beam as a reference to perform beam sweeping based on pre-configured pattern can be generalized to more complicated scenarios. A serving beam can be taken as beam oo or any ij, and the relative beam sweeping pattern can be indexed by [kl, mn . . . ] in a beam mapping which can be pre-configured to the UE supporting large number of beams in the space. The beam sweeping direction can be from the beam with low number to the beam with high number and circling back.

The above embodiment provides the details on how the beam pattern is determined based on the UE trajectory and the neighbouring TRPs at the border area and how the beam sweeping pattern can be practically used by the UE for initial candidate beam search.

The above embodiment provides a method for UE to perform the beam sweeping for initial candidate beam search and acquisition based on a pre-configured beam sweeping pattern. With this method, the time for initial beam acquisition can be largely reduced. As a result, the beam selection and L1 measurement delay can be significantly reduced.

FIG. 23B shows an example of L1 measurement configuration and procedure flow chart for sequential mobility at the UE side, according to some embodiments. At the operation 2321, upon received mobility pre-configuration including L1 measurement configurations for the current serving cell and the predicted candidate cells on the UE trajectory, the UE applies the L1 measurement configuration for the current serving cell and stores the per-cell L1 measurement configurations of each of the predicted candidate cells. The L1 measurement configuration for a candidate cell is stored by the UE and will only be used by the UE when the candidate cell becomes the new serving cell of the UE after a cell switch. At the operation 2322, the UE perform the L1 measurement on the candidate beam(s) of the candidate cell(s) of the current serving cell only, based on the L1 measurement configuration of the current serving cell. If the beam sweeping pattern is configured, the UE based on the beam switching pattern performs initial beam sweeping/searching for the candidate beams of current serving cell. The UE reports the measurement results to the current serving cell based on the configuration for the current serving cell. At the operation 2323, the UE determines whether a cell switch is triggered. If so, at the operation 2324, upon the completion of the cell switch, the candidate target cell becomes the new serving cell of the UE. The UE applies the L1 measure configuration corresponding to the new serving cell as the configuration of the new serving cell.

FIG. 23C shows an example of L1 measurement configuration and procedure flow chart for sequential mobility at the network side, according to some embodiments. At the operation 2331, based on the trajectory prediction, the network centralized unit (CU) determines the mobility candidate cells on a predicted UE trajectory for sequential cell switch. Each candidate cell is also a potential serving cell in the future after a cell switch. The network CU starts the mobility preparation and pre-configuration. At the operation 2332, the network CU sends the mobility pre-configuration request to the candidate distributed units (DUs)/cells via F1 interface messages. The network CU indicates to a candidate DU/cell the identities of the current serving cell and/or the potential serving cell(s) of the candidate cell. At the operation 2333, upon receiving the pre-configuration request, the candidate DU/cell responds to the network CU with candidate target cell L1 measurement configurations, including the candidate beam(s) for the current serving cell and/or candidate beam(s) for each potential future serving cell of this candidate DU/cell. At the operation 2334, the candidate DU/cell is ready for the UE to perform cell switch and initial access. After the cell switch is completed, the candidate cell becomes a new serving cell of the UE, and starts to receive the L1 measurement reports from the UE. At the operation 2335, after received all the response, the network CU combines L1 measurement configurations for the candidate beams from all the candidate cell(s) of the current serving cell to form the L1 measurement configuration of the current serving cell, and/or combines L1 measurement configurations for the candidate beams from all the candidate cell(s) of the potential serving cell(s) to form the L1 measurement configuration(s) of each of the potential serving cell(s). At the operation 2336, the network CU sends the prepared sequential mobility pre-configuration to the serving source DU/cell, including the per cell L1 measurement configurations of the current serving cell and potential serving cells (current candidate cells). The serving DU/cell sends the pre-configuration to the UE via an RRC message.

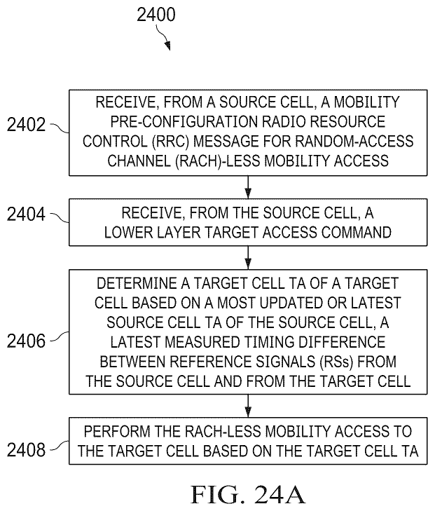

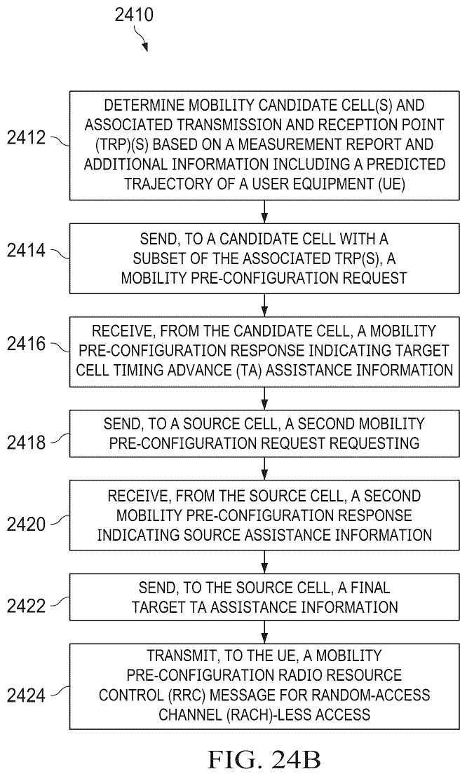

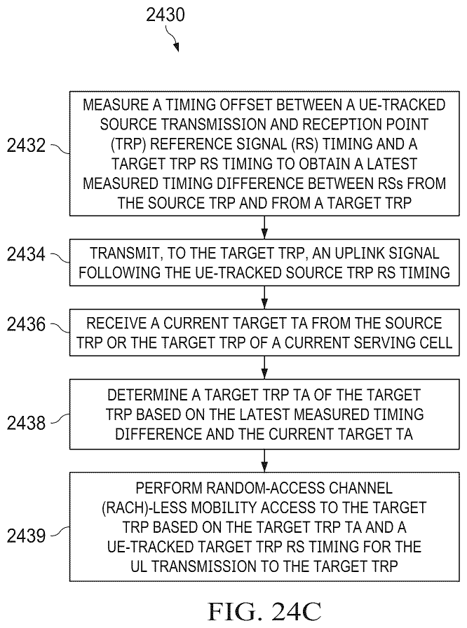

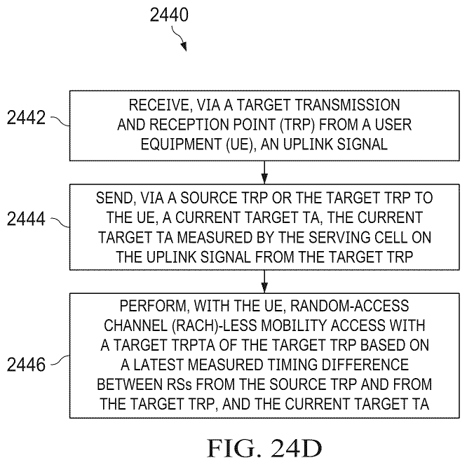

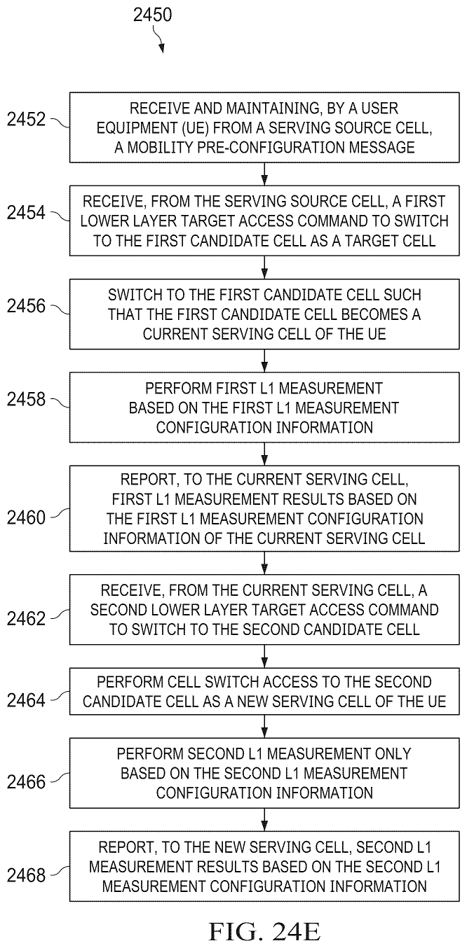

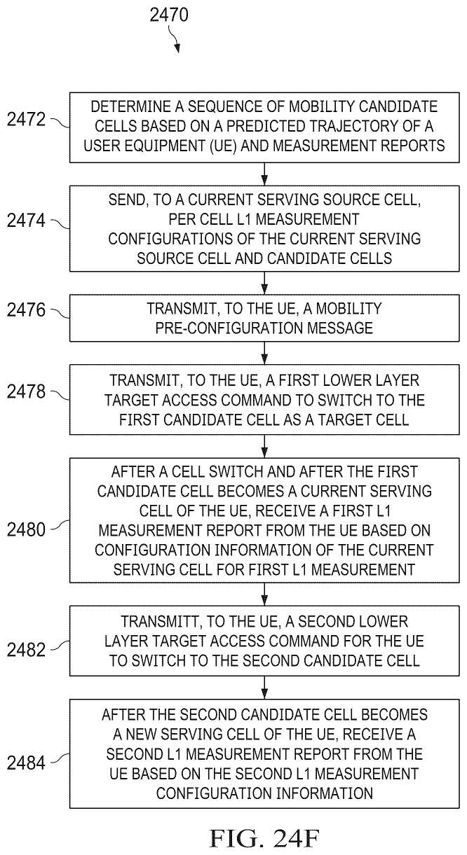

FIG. 24A illustrates a flow chart of a method 2400 performed by a UE, according to some embodiments. The UE may include computer-readable code or instructions executing on one or more processors of the UE. Coding of the software for carrying out or performing the method 2400 is well within the scope of a person of ordinary skill in the art having regard to the present disclosure. The method 2400 may include additional or fewer operations than those shown and described and may be carried out or performed in a different order. Computer-readable code or instructions of the software executable by the one or more processors may be stored on a non-transitory computer-readable medium, such as for example, the memory of the UE.

The method 2400 starts the operation 2402, where the UE receives, from a source cell, a mobility pre-configuration radio resource control (RRC) message for random-access channel (RACH)-less access. The mobility pre-configuration RRC message indicates target timing advance (TA) assistance information. At the operation 2404, the UE receives, from the source cell, a lower layer target access command. The lower layer target access command indicates a most updated or latest network-updated time sensitive dynamic TA assistance information. At the operation 2406, the UE determines a target cell TA of a target cell based on a latest source cell TA of the source cell, a latest measured timing difference between reference signals (RSs) from the source cell and from the target cell, the most updated or latest network-updated time sensitive dynamic TA assistance information, and the target TA assistance information. At the operation 2108, the UE performs the RACH-less access to the target cell based on the target cell TA.

In some embodiments, the UE may indicate to the target cell a reference signal (RS) of a target beam selected by the UE by transmitting a corresponding sounding RS (SRS) or a RS identifier (ID) in an initial message.

In some embodiments, the UE may maintain pre-configured mobility parameters without performing cell switch and access to a candidate cell until the lower layer target access command is received or a cell switch triggering condition is met. The UE may perform a layer 1 (L1) measurement and tracking timing of reference signals from candidate beams to maintain synchronization with the candidate beams by periodically measuring, updating, and storing timing offsets of the candidate beams relative to a local reference time of the UE based on the pre-configured mobility parameters. The UE may update new mobility configuration parameters including the target timing TA assistance information after a mobility delta configuration message is received. The UE may apply the new mobility configuration parameters of the target cell responsive to the lower layer target access command being received or the cell switch triggering condition being met.

In some embodiments, upon the receiving the low layer target access command or a cell switch triggering condition being met at the UE, the UE may transmit, to the target cell, a RACH-less initial message and an SRS using (1) the target cell TA over a timing of an RS from a target beam of the target cell selected by the UE, (2) a pre-configured SRS uniquely corresponding to the RS from the target beam of the target cell, and (3) a pre-configured grant for the RACH-less initial message. The pre-configured grant may be pre-determined by the target cell and pre-configured to the UE at a per candidate cell basis. The RACH-less initial message may include lower layer information.

In some embodiments, the lower layer information may include a media access control (MAC) control element (CE) indicating an ID of the RS from the target beam of the target cell. The ID may be one of a synchronization signal block (SSB) ID or a channel state information (CSI) RS ID.

In some embodiments, the MAC CE may further indicate at least one of a buffer status report (BSR) or a power headroom report (PHR).

In some embodiments, the UE configured for conditional mobility may perform updates on the latest source cell TA, a source cell reference signal timing, and a target cell reference signal timing currently maintained by the UE based on the most updated or latest network-updated time sensitive dynamic TA assistance information received from the source cell. The conditional mobility may be one of conditional primary cell of secondary cell group (PSCell) addition or change (CPAC) or conditional handover (CHO). Upon a mobility condition being met, the UE configured for the conditional mobility may trigger the target cell TA derived based on the latest source cell TA, the latest measured timing difference between the RSs from the source cell and from the target cell, and the most updated or latest network-updated time sensitive dynamic TA assistance information.

In some embodiments, upon the UE configured for the CHO considering that the target cell TA determined by the UE is not valid anymore after expiry of timing alignment timer (TAT) for the latest source cell TA, the UE may perform legacy random access to the target cell.

FIG. 24B illustrates a flow chart of a method 2410 performed by one or more network nodes, according to some embodiments. The one or more network nodes may include computer-readable code or instructions executing on one or more processors of the one or more network nodes. Coding of the software for carrying out or performing the method 2410 is well within the scope of a person of ordinary skill in the art having regard to the present disclosure. The method 2410 may include additional or fewer operations than those shown and described and may be carried out or performed in a different order. Computer-readable code or instructions of the software executable by the one or more processors may be stored on non-transitory computer-readable medium(s), such as for example, the memor(ies) of the one or more network nodes.

The method 2410 starts at the operation 2412, where a centralized unit (CU) determines mobility candidate cell(s) and associated transmission and reception point (TRP) (s) based on a measurement report and additional information including a predicted trajectory of a user equipment (UE). At the operation 2414, the CU sends to a candidate cell with a subset of the associated TRP(s), a mobility pre-configuration request. At the operation 2416, the CU receives, from the candidate cell, a mobility pre-configuration response indicating target cell timing advance (TA) assistance information. At the operation 2418, the CU sends, to a source cell, a second mobility pre-configuration request requesting. At the operation 2420, the CU receives, from the source cell, a second mobility pre-configuration response indicating source assistance information. At the operation 2422, the CU sends, to the source cell, a final target TA assistance information. At the operation 2424, the source cell transmits, to the UE, a mobility pre-configuration radio resource control (RRC) message for random-access channel (RACH)-less access. The mobility pre-configuration RRC message indicates the target TA assistance information.

In some embodiments, the mobility pre-configuration request may indicate a time stamp of a CU transmission timing. The target cell TA assistance information from the candidate cell may indicate a candidate cell transmission timing difference relative to the CU transmission timing and a first DL/UL asymmetry factor(s) of the candidate cell. The source cell TA assistance information from the source cell may include a source cell transmission timing difference relative to the CU transmission timing and a second DL/UL asymmetry factor(s) of the source cell.

In some embodiments, the candidate cell may determine the candidate cell transmission timing difference from the CU based on the time stamp and a first mid-haul delay between the CU and the candidate cell. The source cell may determine the source cell transmission timing difference from the CU based on the CU time stamp and a second mid-haul delay between the CU and the source cell. The CU may determine a transmission timing difference between the source cell and a target cell based on the source cell transmission timing difference and a target cell transmission timing difference from the CU. The CU may combine the source cell TA assistance information, the target cell TA assistance information, and the transmission timing difference between the source cell and the target cell to generate the final target TA assistance information.

In some embodiments, the source cell may send dynamic TA assistance information to the UE configured for conditional mobility triggered by at least one of: a source node one way delay (OWD) or a source TA change being above a threshold, and/or the change of transmission timing difference between the source cell and the target cell updated by the CU being above a timing offset threshold.

FIG. 24C illustrates a flow chart of a method 2300 performed by a UE, according to some embodiments. The UE may include computer-readable code or instructions executing on one or more processors of the UE. Coding of the software for carrying out or performing the method 2430 is well within the scope of a person of ordinary skill in the art having regard to the present disclosure. The method 2430 may include additional or fewer operations than those shown and described and may be carried out or performed in a different order. Computer-readable code or instructions of the software executable by the one or more processors may be stored on a non-transitory computer-readable medium, such as for example, the memory of the UE.

The method 2430 starts the operation 2432, where the UE measures a timing offset between a UE-tracked source transmission and reception point (TRP) reference signal (RS) timing and a target TRP RS timing to obtain a latest measured timing difference between RSs from the source TRP and from a target TRP. At the operation 2434, the UE transmits, to the target TRP, an uplink signal following the UE-tracked source TRP RS timing. At the operation 2436, the UE receives a current target TA from the source TRP or the target TRP of a current serving cell. The current target TA is measured by the current serving cell of the source TRP and the target TRP on the uplink signal aligning with the UE-tracked source TRP RS timing received via the target TRP. At the operation 2438, the UE determines a target TRP TA of the target TRP based on the latest measured timing difference and the current target TA. At the operation 2439, the UE performs RACH-less access to the target TRP based on the target TRP TA and a UE-tracked target TRP RS timing for the UL transmission to the target TRP.

In some embodiments, the uplink signal may be a sounding reference signal (SRS).

In some embodiments, the UE may adjust the current target TA based on the UE-tracked source TRP RS timing with the timing offset between the UE-tracked source TRP RS timing and the target TRP RS timing to obtain the target TRP TA when the UE starts to use the target TRP RS timing as a local reference to perform the UL transmission to the target TRP.

FIG. 24D illustrates a flow chart of a method 2440 performed by one or more network nodes, according to some embodiments. The one or more network nodes may include computer-readable code or instructions executing on one or more processors of the one or more network nodes. Coding of the software for carrying out or performing the method 2440 is well within the scope of a person of ordinary skill in the art having regard to the present disclosure. The method 2440 may include additional or fewer operations than those shown and described and may be carried out or performed in a different order. Computer-readable code or instructions of the software executable by the one or more processors may be stored on non-transitory computer-readable medium(s), such as for example, the memor(ies) of the one or more network nodes.

The method 2440 starts at the operation 2442, where a serving cell receives, via a target transmission and reception point (TRP) from a user equipment (UE), an uplink signal. At the operation 2444, the serving cell sends, via a source TRP or the target TRP to the UE, a current target TA, the current target TA measured by the serving cell on the uplink signal from the target TRP. At the operation 2446, the target TRP performs with the UE RACH-less access with a target TRPTA of the target TRP based on a latest measured timing difference between RSs from the source TRP and from the target TRP, and the current target TA.

FIG. 24E illustrates a flow chart of a method 2450 performed by a UE, according to some embodiments. The UE may include computer-readable code or instructions executing on one or more processors of the UE. Coding of the software for carrying out or performing the method 2550 is well within the scope of a person of ordinary skill in the art having regard to the present disclosure. The method 2450 may include additional or fewer operations than those shown and described and may be carried out or performed in a different order. Computer-readable code or instructions of the software executable by the one or more processors may be stored on a non-transitory computer-readable medium, such as for example, the memory of the UE.

The method 2450 starts the operation 2452, where the UE receives and maintains, from a serving source cell, a mobility pre-configuration message. The mobility pre-configuration message indicates L1 measurement configuration information of the serving source cell, first L1 measurement configuration information of a first candidate cell, and second L1 measurement configuration information of a second candidate cell. The second candidate cell is a subsequent cell of the first candidate cell on a predicted trajectory of the UE. At the operation 2454, the UE receives, from the serving source cell, a first lower layer target access command to switch to the first candidate cell as a target cell. At the operation 2456, the UE switches to the first candidate cell such that the first candidate cell becomes a current serving cell of the UE. At the operation 2458, the UE performs first L1 measurement based on the first L1 measurement configuration information. At the operation 2460, the UE reports, to the current serving cell, first L1 measurement results based on the first L1 measurement configuration information of the current serving cell. At the operation 2462, the UE receives, from the current serving cell, a second lower layer target access command to switch to the second candidate cell. At the operation 2464, the UE performs cell switch access to the second candidate cell as a new serving cell of the UE. At the operation 2466, the UE in the new serving cell performs second L1 measurement only based on the second L1 measurement configuration information. At the operation 2468, the UE reports, to the new serving cell, second L1 measurement results based on the second L1 measurement configuration information.

In some embodiments, the mobility pre-configuration message may be in a radio resource control (RRC) message.

In some embodiments, the L1 measurement configuration information of the serving source cell may include all L1 measurement configurations for all candidate beams of candidate cells of the serving source cell.

In some embodiments, the first L1 measurement configuration information of the first candidate cell may include all L1 measurement configurations for all candidate beams of candidate cells of the first candidate cell. The second L1 measurement configuration information of the second candidate cell may include all L1 measurement configurations for all the candidate beams of candidate cells of the second candidate cell. The first and second L1 measurement configurations described here are purely for illustration purpose without losing the generality. The number of candidate cells (and the corresponding L1 measurement configuration information) for sequential cell switch can be more (e.g., all candidate cells in the predicted trajectory of the UE).

In some embodiments, L1 measurement configuration information of the current serving cell or a candidate cell may indicate a corresponding candidate beam sweeping pattern. A candidate sweeping pattern includes a serving beam from a current or potential serving cell and the candidate beams associated with the serving beam.

In some embodiments, the UE may select a candidate beam sweeping pattern based on a current serving beam. The UE may use the current serving beam as a reference beam to perform candidate beam sweeping and candidate beam search based on the candidate beam sweeping pattern.

In some embodiments, the first L1 measurement configuration information and the second L1 measurement configuration information may be per cell based.

FIG. 24F illustrates a flow chart of a method 2470 performed by one or more network nodes, according to some embodiments. The one or more network nodes may include computer-readable code or instructions executing on one or more processors of the one or more network nodes. Coding of the software for carrying out or performing the method 2470 is well within the scope of a person of ordinary skill in the art having regard to the present disclosure. The method 2470 may include additional or fewer operations than those shown and described and may be carried out or performed in a different order. Computer-readable code or instructions of the software executable by the one or more processors may be stored on non-transitory computer-readable medium(s), such as for example, the memor(ies) of the one or more network nodes.

The method 2470 starts at the operation 2472, where a CU determines a sequence of mobility candidate cells based on a predicted trajectory of a user equipment (UE) and measurement reports. At the operation 2474, the CU sends, to a current serving source cell, per cell L1 measurement configurations of the current serving source cell and candidate cells. The per cell L1 measurement configurations include beam sweeping pattern(s) in a L1 measurement configuration of each cell. At the operation 2476, the current serving source cell transmits, to the UE, a mobility pre-configuration message. The mobility pre-configuration message indicates L1 measurement configuration information of the current serving source cell, first L1 measurement configuration information of a first candidate cell, and second L1 measurement configuration information of a second candidate cell. The second candidate cell is a subsequent cell of the first candidate cell on the predicted trajectory of the UE. At the operation 2478, the current serving source cell transmits, to the UE, a first lower layer target access command to switch to the first candidate cell as a target cell. At the operation 2480, after a cell switch and after the first candidate cell becomes a current serving cell of the UE, the current serving cell receives a first L1 measurement report from the UE based on configuration information of the current serving cell for first L1 measurement. At the operation 2482, the current serving cell transmits, to the UE, a second lower layer target access command for the UE to switch to the second candidate cell. At the operations 2484, after the second candidate cell becomes a new serving cell of the UE, the new serving cell receives a second L1 measurement report from the UE based on the second L1 measurement configuration information.

In some embodiments, the CU may indicate, in a mobility request in a mobility preparation phase to a candidate cell on the predicted trajectory of the UE, the current serving cell and potential serving cell(s) of the candidate cell. The candidate cell may report, to the CU, candidate beams and related L1 measurement configurations corresponding to the current serving cell and each of the potential serving cell(s).

In some embodiments, the CU may combine L1 measurement configurations of candidate beam(s) of all candidate cell(s) for the current serving cell, as L1 measurement configurations of current serving cell.

In some embodiments, the CU may combine the L1 measurement configurations of the candidate beam(s) of all the candidate cell(s) for each potential serving cell, which is currently a mobility candidate cell on the predicted trajectory of the UE, as the L1 measurement configuration of each of the candidate cell(s).

In some embodiments, the CU may determine, based on the predicted trajectory of the UE, a beam sweeping pattern of candidate beam(s) of candidate cell(s) associated with a first potential serving beam of the current serving cell or a second potential serving beam of potential serving cell(s).

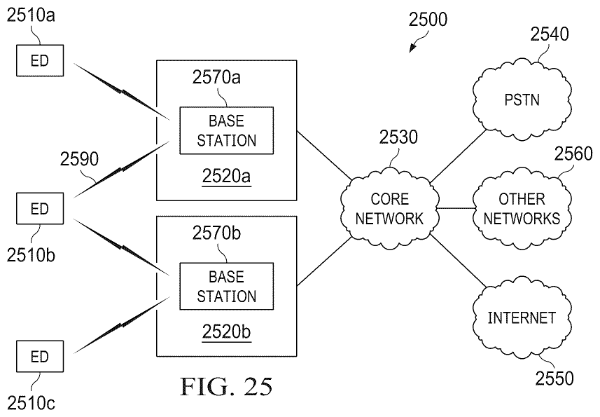

FIG. 25 illustrates an example communication system 2500. In general, the system 2500 enables multiple wireless or wired users to transmit and receive data and other content. The system 2500 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 2500 includes electronic devices (ED) 2510a-2510c, radio access networks (RANs) 2520a-2520b, a core network 2530, a public switched telephone network (PSTN) 2540, the Internet 2550, and other networks 2560. While certain numbers of these components or elements are shown in FIG. 25, any number of these components or elements may be included in the system 2500.

The EDs 2510a-2510c are configured to operate or communicate in the system 2500. For example, the EDs 2510a-2510c are configured to transmit or receive via wireless or wired communication channels. Each ED 2510a-2510c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 2520a-2520b here include base stations 2570a-2570b, respectively. Each base station 2570a-2570b is configured to wirelessly interface with one or more of the EDs 2510a-2510c to enable access to the core network 2530, the PSTN 2540, the Internet 2550, or the other networks 2560. For example, the base stations 2570a-2570b may include (or be) one or more of several well-known devices, such as a base transceiver station (BTS), a Node-B (NodeB), an evolved NodeB (eNB), a Next Generation (NG) NodeB (gNB), a gNB centralized unit (gNB-CU), a gNB distributed unit (gNB-DU), a Home NodeB, a Home eNodeB, a site controller, an access point (AP), or a wireless router. The EDs 2510a-2510c are configured to interface and communicate with the Internet 2550 and may access the core network 2530, the PSTN 2540, or the other networks 2560.

In the embodiment shown in FIG. 25, the base station 2570a forms part of the RAN 2520a, which may include other base stations, elements, or devices. Also, the base station 2570b forms part of the RAN 2520b, which may include other base stations, elements, or devices. Each base station 2570a-2570b operates to transmit or receive wireless signals within a particular geographic region or area, sometimes referred to as a “cell.” In some embodiments, multiple-input multiple-output (MIMO) technology may be employed having multiple transceivers for each cell.

The base stations 2570a-2570b communicate with one or more of the EDs 2510a-2510c over one or more air interfaces 2590 using wireless communication links. The air interfaces 2590 may utilize any suitable radio access technology.

It is contemplated that the system 2500 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 2520a-2520b are in communication with the core network 2530 to provide the EDs 2510a-2510c with voice, data, application, Voice over Internet Protocol (VOIP), or other services. Understandably, the RANs 2520a-2520b or the core network 2530 may be in direct or indirect communication with one or more other RANs (not shown). The core network 2530 may also serve as a gateway access for other networks (such as the PSTN 2540, the Internet 2550, and the other networks 2560). In addition, some or all of the EDs 2510a-2510c may include functionality for communicating with different wireless networks over different wireless links using different wireless technologies or protocols. Instead of wireless communication (or in addition thereto), the EDs may communicate via wired communication channels to a service provider or switch (not shown), and to the Internet 2550.

Although FIG. 25 illustrates one example of a communication system, various changes may be made to FIG. 25. For example, the communication system 2500 could include any number of EDs, base stations, networks, or other components in any suitable configuration.

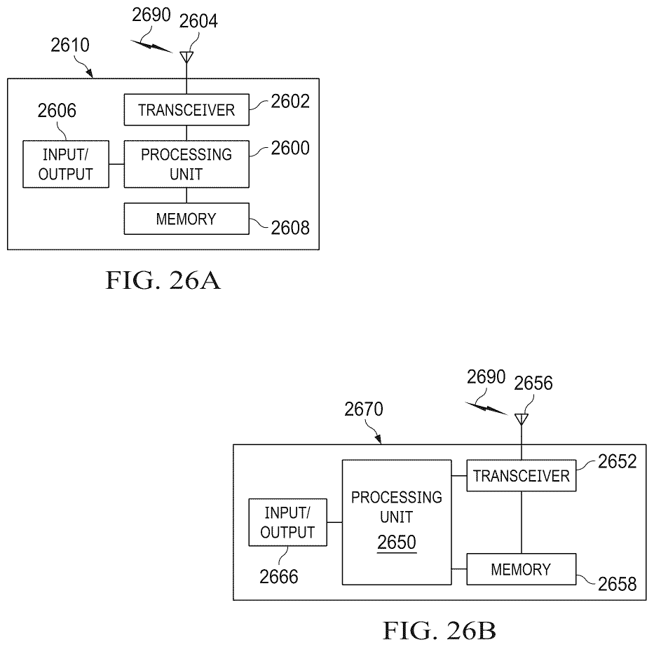

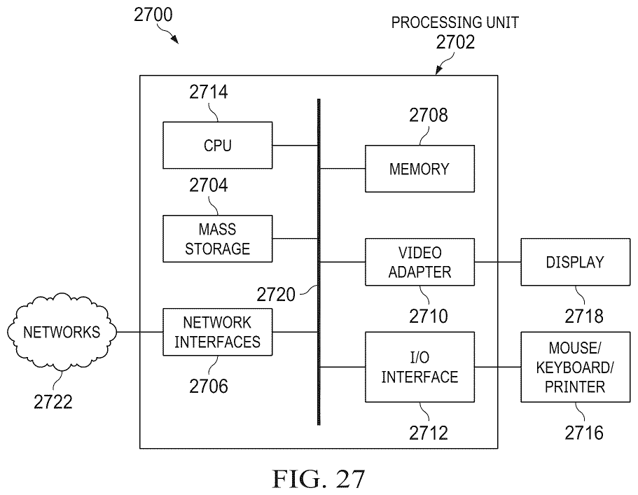

FIGS. 26A and 26B illustrate example devices that may implement the methods and teachings according to this disclosure. In particular, FIG. 26A illustrates an example ED 2610, and FIG. 26B illustrates an example base station 2670. These components could be used in the system 2500 or in any other suitable system.

As shown in FIG. 26A, the ED 2610 includes at least one processing unit 2600. The processing unit 2600 implements various processing operations of the ED 2610. For example, the processing unit 2600 could perform signal coding, data processing, power control, input/output processing, or any other functionality enabling the ED 2610 to operate in the system 2500. The processing unit 2600 also supports the methods and teachings described in more detail above. Each processing unit 2600 includes any suitable processing or computing device configured to perform one or more operations. Each processing unit 2600 could, for example, include a microprocessor, microcontroller, digital signal processor, field programmable gate array, or application specific integrated circuit.

The ED 2610 also includes at least one transceiver 2602. The transceiver 2602 is configured to modulate data or other content for transmission by at least one antenna or NIC (Network Interface Controller) 2604. The transceiver 2602 is also configured to demodulate data or other content received by the at least one antenna 2604. Each transceiver 2602 includes any suitable structure for generating signals for wireless or wired transmission or processing signals received wirelessly or by wire. Each antenna 2604 includes any suitable structure for transmitting or receiving wireless or wired signals. One or multiple transceivers 2602 could be used in the ED 2610, and one or multiple antennas 2604 could be used in the ED 2610. Although shown as a single functional unit, a transceiver 2602 could also be implemented using at least one transmitter and at least one separate receiver.

The ED 2610 further includes one or more input/output devices 2606 or interfaces (such as a wired interface to the Internet 2550). The input/output devices 2606 facilitate interaction with a user or other devices (network communications) in the network. Each input/output device 2606 includes any suitable structure for providing information to or receiving information from a user, such as a speaker, microphone, keypad, keyboard, display, or touch screen, including network interface communications.

In addition, the ED 2610 includes at least one memory 2608. The memory 2608 stores instructions and data used, generated, or collected by the ED 2610. For example, the memory 2608 could store software or firmware instructions executed by the processing unit(s) 2600 and data used to reduce or eliminate interference in incoming signals. Each memory 2608 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 26B, the base station 2670 includes at least one processing unit 2650, at least one transceiver 2652, which includes functionality for a transmitter and a receiver, one or more antennas 2656, at least one memory 2658, and one or more input/output devices or interfaces 2666. A scheduler, which would be understood by one skilled in the art, is coupled to the processing unit 2650. The scheduler could be included within or operated separately from the base station 2670. The processing unit 2650 implements various processing operations of the base station 2670, such as signal coding, data processing, power control, input/output processing, or any other functionality. The processing unit 2650 can also support the methods and teachings described in more detail above. Each processing unit 2650 includes any suitable processing or computing device configured to perform one or more operations. Each processing unit 2650 could, for example, include a microprocessor, microcontroller, digital signal processor, field programmable gate array, or application specific integrated circuit.

Each transceiver 2652 includes any suitable structure for generating signals for wireless or wired transmission to one or more EDs or other devices. Each transceiver 2652 further includes any suitable structure for processing signals received wirelessly or by wire from one or more EDs or other devices. Although shown combined as a transceiver 2652, a transmitter and a receiver could be separate components. Each antenna 2656 includes any suitable structure for transmitting or receiving wireless or wired signals. While a common antenna 2656 is shown here as being coupled to the transceiver 2652, one or more antennas 2656 could be coupled to the transceiver(s) 2652, allowing separate antennas 2656 to be coupled to the transmitter and the receiver if equipped as separate components. Each memory 2658 includes any suitable volatile or non-volatile storage and retrieval device(s). Each input/output device 2666 facilitates interaction with a user or other devices (network communications) in the network. Each input/output device 2666 includes any suitable structure for providing information to or receiving/providing information from a user, including network interface communications.

FIG. 27 is a block diagram of a computing system 2700 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 2700 includes a processing unit 2702. The processing unit includes a central processing unit (CPU) 2714, memory 2708, and may further include a mass storage device 2704, a video adapter 2710, and an I/O interface 2712 connected to a bus 2720.

The bus 2720 may be one or more of any type of several bus architectures including a memory bus or memory controller, a peripheral bus, or a video bus. The CPU 2714 may comprise any type of electronic data processor. The memory 2708 may comprise any type of non-transitory system memory such as static random access memory (SRAM), dynamic random access memory (DRAM), synchronous DRAM (SDRAM), read-only memory (ROM), or a combination thereof. In an embodiment, the memory 2708 may include ROM for use at boot-up, and DRAM for program and data storage for use while executing programs.

The mass storage 2704 may comprise any type of non-transitory storage device configured to store data, programs, and other information and to make the data, programs, and other information accessible via the bus 2720. The mass storage 2704 may comprise, for example, one or more of a solid state drive, hard disk drive, a magnetic disk drive, or an optical disk drive.

The video adapter 2710 and the I/O interface 2712 provide interfaces to couple external input and output devices to the processing unit 2702. As illustrated, examples of input and output devices include a display 2718 coupled to the video adapter 2710 and a mouse, keyboard, or printer 2716 coupled to the I/O interface 2712. Other devices may be coupled to the processing unit 2702, and additional or fewer interface cards may be utilized. For example, a serial interface such as Universal Serial Bus (USB) (not shown) may be used to provide an interface for an external device.

The processing unit 2702 also includes one or more network interfaces 2706, which may comprise wired links, such as an Ethernet cable, or wireless links to access nodes or different networks. The network interfaces 2706 allow the processing unit 2702 to communicate with remote units via the networks. For example, the network interfaces 2706 may provide wireless communication via one or more transmitters/transmit antennas and one or more receivers/receive antennas. In an embodiment, the processing unit 2702 is coupled to a local-area network 2722 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of this disclosure.

What is claimed is:

1. A user equipment (UE), comprising:
at least one processor; and
a non-transitory computer readable storage medium storing programming, the programming including instructions that, when executed by the at least one processor, cause the UE to perform operations including:
receiving, from a source cell, a radio resource control (RRC) message for random-access channel (RACH)-less mobility access, the RRC message indicating pre-configured target timing advance (TA) assistance information;
receiving, from the source cell, a lower layer target access command at a protocol layer lower than an RRC layer, the lower layer target access command indicating a most updated or latest network-updated time sensitive dynamic TA assistance information;
determining a target cell TA of a target cell based on a most updated or latest source cell TA of the source cell, a latest measured timing difference between a reference signal (RS) from the source cell and a reference signal from the target cell, the most updated or latest network-updated time sensitive dynamic TA assistance information, and the pre-configured target TA assistance information; and
performing the RACH-less mobility access to the target cell based on the target cell TA.

2. The UE of claim 1, the operations further comprising:
maintaining pre-configured mobility parameters without performing cell switch and access to a candidate cell until the lower layer target access command is received or a cell switch triggering condition is met;
performing a layer 1 (L1) measurement and tracking timing of reference signals from candidate beams to maintain synchronization with the candidate beams by periodically measuring, updating, and storing timing offsets of the candidate beams relative to a local reference time of the UE based on the pre-configured mobility parameters;
updating new mobility configuration parameters including the target timing TA assistance information after a mobility delta configuration message is received; and
applying the new mobility configuration parameters of the target cell responsive to the lower layer target access command being received or the cell switch triggering condition being met.

3. The UE of claim 1, the performing the RACH-less mobility access to the target cell comprising:
upon the receiving the low layer target access command or a cell switch triggering condition being met at the UE, transmitting, to the target cell, a RACH-less initial message and an SRS using (1) the target cell TA over a timing of an RS from a target beam of the target cell selected by the UE, (2) a pre-configured SRS uniquely corresponding to the RS from the target beam of the target cell, and (3) a pre-configured grant for the RACH-less initial message, wherein the pre-configured grant is pre-determined by the target cell and pre-configured to the UE at a per candidate cell basis, and
wherein the RACH-less initial message includes lower layer information.

4. The UE of claim 3, the lower layer information includes a media access control (MAC) control element (CE) indicating an identifier (ID) of the RS from the target beam of the target cell, the ID being one of a synchronization signal block (SSB) ID or a channel state information (CSI) RS ID.

5. The UE of claim 4, the MAC CE further indicating at least one of a buffer status report (BSR) or a power headroom report (PHR).

6. The UE of claim 1, the operations further comprising:
performing, by the UE configured for conditional mobility, updates on the most updated or latest source cell TA, a source cell reference signal timing, and a target cell reference signal timing currently maintained by the UE based on the most updated or latest network-updated time sensitive dynamic TA assistance information received from the source cell, the conditional mobility being one of conditional primary cell of secondary cell group (PSCell) addition or change (CPAC) or conditional handover (CHO); and
triggering, by the UE configured for the conditional mobility, upon a mobility condition being met, derivation of the target cell TA at the UE based on the most updated or latest source cell TA, the latest measured timing difference between RSs from the source cell and from the target cell, and the most updated or latest network-updated time sensitive dynamic TA assistance information.

7. The UE of claim 6, wherein, upon the UE configured for the CHO considering that the target cell TA determined by the UE is not valid anymore after expiry of timing alignment timer (TAT) for the latest source cell TA, the UE performs legacy random access to the target cell.

8. A user equipment (UE), comprising:
at least one processor; and
a non-transitory computer readable storage medium storing programming, the programming including instructions that, when executed by the at least one processor, cause the UE to perform operations including:
measuring a timing offset between a UE-tracked source transmission and reception point (TRP) reference signal (RS) timing and a target TRP RS timing to obtain a latest measured timing difference between RSs from the source TRP and from a target TRP;
transmitting, to the target TRP, an uplink signal following the UE-tracked source TRP RS timing;
receiving a current target TA from the source TRP or the target TRP of a current serving cell, the current target TA measured by the current serving cell of the source TRP and the target TRP on the uplink signal aligning with the UE-tracked source TRP RS timing for UL transmission to the target TRP;
determining a target TRP TA of the target TRP based on the latest measured timing difference and the current target TA; and
performing random-access channel (RACH)-less mobility access to the target TRP based on the target TRP TA and a UE-tracked target TRP RS timing for the UL transmission to the target TRP.

9. The UE of claim 8, the uplink signal being a sounding reference signal (SRS).

10. The UE of claim 8, the determining the target TRP TA comprising:
adjusting the current target TA based on the UE-tracked source TRP RS timing with the timing offset between the UE-tracked source TRP RS timing and the target TRP RS timing to obtain the target TRP TA when the UE starts to use the target TRP RS timing as a local reference to perform the UL transmission to the target TRP.

11. A user equipment (UE), comprising:
at least one processor; and
a non-transitory computer readable storage medium storing programming, the programming including instructions that, when executed by the at least one processor, cause the UE to perform operations including:
receiving and maintaining, from a serving source cell, a mobility pre-configuration message, the mobility pre-configuration message indicating layer 1 (L1) measurement configuration information of the serving source cell, first L1 measurement configuration information of a first candidate cell, and second L1 measurement configuration information of a second candidate cell, the second candidate cell being a subsequent cell of the first candidate cell on a predicted trajectory of the UE;
receiving, from the serving source cell, a first lower layer target access command to switch to the first candidate cell as a target cell;
switching to the first candidate cell such that the first candidate cell becomes a current serving cell of the UE;
performing first L1 measurement based on the first L1 measurement configuration information;
reporting, to the current serving cell, first L1 measurement results based on the first L1 measurement configuration information of the current serving cell;
receiving, from the current serving cell, a second lower layer target access command to switch to the second candidate cell;
performing cell switch access to the second candidate cell as a new serving cell of the UE;
performing, by the UE in the new serving cell, second L1 measurement only based on the second L1 measurement configuration information; and
reporting, to the new serving cell, second L1 measurement results based on the second L1 measurement configuration information.

12. The UE of claim 11, the mobility pre-configuration message being in a radio resource control (RRC) message.

13. The UE of claim 11, the L1 measurement configuration information of the serving source cell including all L1 measurement configurations for all candidate beams of candidate cells of the serving source cell.

14. The UE of claim 11, the first L1 measurement configuration information of the first candidate cell including all L1 measurement configurations for all candidate beams of candidate cells of the first candidate cell, the second L1 measurement configuration information of the second candidate cell including all L1 measurement configurations for all the candidate beams of candidate cells of the second candidate cell.

15. The UE of claim 11, L1 measurement configuration information of the current serving cell or a candidate cell indicating a corresponding candidate beam sweeping pattern.

16. The UE of claim 15, the operations further comprising:
selecting a candidate beam sweeping pattern based on a current serving beam; and
using the current serving beam as a reference beam to perform candidate beam sweeping and candidate beam search based on the candidate beam sweeping pattern.

17. The UE of claim 11, the first L1 measurement configuration information and the second L1 measurement configuration information being per cell based.

18. A method, comprising:
determining, by a centralized unit (CU), mobility candidate cell(s) and associated transmission and reception point (TRP) (s) based on a measurement report and additional information including a predicted trajectory of a user equipment (UE);
sending, by the CU to a candidate cell with a subset of the associated TRP(s), a mobility pre-configuration request;
receiving, by the CU from the candidate cell, a mobility pre-configuration response indicating target cell timing advance (TA) assistance information;
sending, by the CU to a source cell, a second mobility pre-configuration request requesting; and
receiving, by the CU from the source cell, a second mobility pre-configuration response indicating source assistance information;
sending, by the CU to the source cell, a final target TA assistance information; and
transmitting, by the source cell to the UE, a radio resource control (RRC) message for random-access channel (RACH)-less access, the RRC message indicating the target TA assistance information.

19. The method of claim 18,
the mobility pre-configuration request indicating a time stamp of a CU transmission timing,
the target cell TA assistance information from the candidate cell indicating a candidate cell transmission timing difference relative to the CU transmission timing and a first DL/UL asymmetry factor(s) of the candidate cell, and
the source cell TA assistance information from the source cell including a source cell transmission timing difference relative to the CU transmission timing and a second DL/UL asymmetry factor(s) of the source cell.

20. The method of claim 19, further comprising:
determining, by the candidate cell, the candidate cell transmission timing difference from the CU based on the time stamp and a first mid-haul delay between the CU and the candidate cell;
determining, by the source cell, the source cell transmission timing difference from the CU based on the CU time stamp and a second mid-haul delay between the CU and the source cell;
determining, by the CU, a transmission timing difference between the source cell and a target cell based on the source cell transmission timing difference and a target cell transmission timing difference; and
combining, by the CU, the source cell TA assistance information, the target cell TA assistance information, and the transmission timing difference between the source cell and the target cell to generate the final target TA assistance information.

21. The method of claim 20, further comprising:
sending, by the source cell, dynamic TA assistance information to the UE configured for conditional mobility triggered by at least one of: a source node one way delay (OWD) or a source TA being above a threshold or the transmission timing difference between the source cell and the target cell updated by the CU being above a timing offset threshold.
